(19) United States
(12) Patent Application Publication
(10) Pub. No.: US 2024/0422868 A1
(43) Pub. Date: Dec. 19, 2024

(54) MICROWAVE HEATING DEVICE

(71) Applicant: Panasonic Intellectual Property Management Co., Ltd., Osaka (JP)

(72) Inventors: Kazuki MAEDA, Shiga (JP); Daisuke HOSOKAWA, Shiga (JP); Yoshiharu OOMORI, Shiga (JP)

(21) Appl. No.: 18/703,957

(22) PCT Filed: Oct. 21, 2022
(86) PCT No.: PCT/JP2022/039257

§ 371 Date: Apr. 23, 2024

(30) Foreign Application Priority Data
Oct. 27, 2021 (JP) 2021-175778

(51) Int. Cl. H05B 6/64

(52) U.S. Cl. CPC H05B 6/6402

(57) ABSTRACT

A microwave heating device includes: a heating chamber in which objects to be heated are placed; a microwave generator that generates microwaves; a microwave radiator that radiates the microwaves generated by the microwave generator into the heating chamber; and a divider that divides a space of the heating chamber into at least two divided chambers.

### TECHNICAL FIELD

The present disclosure relates to a microwave heating device.

### BACKGROUND ART

A microwave heating device in which an object to be heated such as food is accommodated in a heating chamber, and microwaves are fed into the heating chamber to heat and cook the object to be heated is conventionally known (see, for example, Patent Document 1).

The microwave heating device of Patent Document 1 includes a microwave generator that generates microwaves, and a microwave radiator that radiates the microwaves generated by the microwave generator into the heating chamber.

### PRIOR ART DOCUMENT

### Patent Document

Patent Document 1: JP-A-2014-229532

### SUMMARY OF THE INVENTION

### Problems to be Solved by the Invention

The present disclosure provides a microwave heating device that enables cooking that is more suitable for an object to be heated.

### Solutions to the Problems

A microwave heating device according to one aspect of the present disclosure includes: a heating chamber in which an object to be heated is disposed; a microwave generator that generates microwaves; a microwave radiator that radiates microwaves generated by the microwave generator into the heating chamber; and a divider that divides a space of the heating chamber into at least two divided chambers.

### Effects of the Invention

According to the present disclosure, cooking that is more suitable for an object to be heated is possible.

### BRIEF DESCRIPTION OF THE DRAWINGS

FIG. 1 is a schematic front view of a configuration example of a microwave heating device according to a first embodiment.

FIG. 2 is a flowchart showing an example of operation of the microwave heating device according to the first embodiment.

FIG. 3 is a flowchart showing an example of operation of the microwave heating device according to the first embodiment.

FIG. 4 is a schematic side view of a configuration example of a microwave heating device according to a second embodiment.

FIG. 5 is a schematic top view of a heating chamber including a divider according to the second embodiment.

FIG. 6 is a schematic perspective view of the divider according to the second embodiment.

FIG. 7 is a schematic side view of the divider according to the second embodiment.

FIG. 8 is a schematic perspective view of the heating chamber including the divider according to the second embodiment.

FIG. 9 is a schematic front view showing a location where the divider and a heating chamber inner wall according to the second embodiment come close to each other.

FIG. 10 is a schematic cross-sectional view of a microwave shielding structure between a radio wave shielding structure and a heating chamber inner wall according to a first modification of the second embodiment.

FIG. 11 is a schematic cross-sectional view of a microwave shielding structure between a radio wave shielding structure and a heating chamber inner wall according to a second modification of the second embodiment.

FIG. 12 is a schematic cross-sectional view of a microwave shielding structure between a radio wave shielding structure and a heating chamber inner wall according to a third modification of the second embodiment.

FIG. 13 is a schematic cross-sectional view of a microwave shielding structure between a radio wave shielding structure and a heating chamber inner wall according to a fourth modification of the second embodiment.

FIG. 14 is a schematic cross-sectional view of a microwave shielding structure between a radio wave shielding structure and a heating chamber inner wall according to a fifth modification of the second embodiment.

FIG. 15 is a schematic cross-sectional view of a microwave shielding structure between a radio wave shielding structure and a heating chamber inner wall according to a sixth modification of the second embodiment.

FIG. 16 is a schematic cross-sectional view of a microwave shielding structure between a radio wave shielding structure and a heating chamber inner wall according to a seventh modification of the second embodiment.

FIG. 17 is a schematic cross-sectional view of a microwave shielding structure between a radio wave shielding structure and a heating chamber inner wall according to an eighth modification of the second embodiment.

FIG. 18A is a schematic side view of a configuration example of a microwave heating device according to a third embodiment.

FIG. 18B is a schematic side view of a configuration example of a microwave heating device according to a modification of the third embodiment.

FIG. 19 is a schematic top view of a divider according to the third embodiment.

FIG. 20 is a schematic cross-sectional view of the divider according to the third embodiment as viewed from the front side.

FIG. 21 is a schematic front view showing an operation example of a rotation antenna according to the third embodiment.

FIG. 22 is a schematic front view showing an operation example of the rotation antenna according to the third embodiment.

FIG. 23 is a schematic front view showing an operation example of the rotation antenna according to the third embodiment.

FIG. 24 is a schematic view regarding a usage example of a microwave sensor using a heating device according to the third embodiment.

FIG. 25 is a flowchart showing an example of operation of the microwave heating device according to the third embodiment.

FIG. 26 is an explanatory diagram of detection of a state change of an object to be heated according to the third embodiment.

FIG. 27 is a flowchart showing an example of operation of the microwave heating device according to the third embodiment.

FIG. 28 is an explanatory diagram of detection of a state change of an object to be heated according to the third embodiment.

FIG. 29 is an explanatory diagram of detection of a state change of an object to be heated according to the third embodiment.

FIG. 30 is an explanatory diagram of detection of a state change of an object to be heated according to the third embodiment.

FIG. 31 is an explanatory diagram of detection of a state change of an object to be heated according to the third embodiment.

FIG. 32 is an explanatory diagram of detection of a state change of an object to be heated according to the third embodiment.

FIG. 33 is a schematic top view of a configuration example of a microwave heating device according to a fourth embodiment.

FIG. 34 is a schematic front view of a configuration example of a microwave heating device according to a fifth embodiment.

FIG. 35 is a schematic side view of a configuration example of a microwave heating device according to a sixth embodiment.

FIG. 36 is a schematic front view of a configuration example of a microwave heating device according to a seventh embodiment.

FIG. 37 is a schematic top view of a configuration example of a microwave heating device according to an eighth embodiment.

FIG. 38 is a schematic top view of a configuration example of a microwave heating device according to a first modification of the eighth embodiment.

FIG. 39 is a schematic top view of a configuration example of a microwave heating device according to a second modification of the eighth embodiment.

FIG. 40 is a schematic top view of a configuration example of a microwave heating device according to a ninth embodiment.

FIG. 41 is a schematic front view of a configuration example of the microwave heating device according to the ninth embodiment.

FIG. 42 is a schematic front view of a configuration example of a microwave heating device according to a tenth embodiment.

FIG. 43 is a view for explaining a heating distribution of an object to be heated in a case of a phase difference 0°.

FIG. 44 is a view for explaining a heating distribution of an object to be heated in a case of a phase difference 180°.

FIG. 45 is a view for explaining a heating distribution of an object to be heated in a case of combining a phase difference 0° and a phase difference 180°.

FIG. 46 is a view for explaining a heating distribution of an object to be heated in a comparative example.

FIG. 47 is a view for explaining a heating distribution of an object to be heated after heating processing is performed in the comparative example.

FIG. 48 is an explanatory diagram of a model used for simulation of a radio wave distribution of a heating chamber and a heating distribution of an object to be heated by a frequency and a phase difference.

FIG. 49 is a view for explaining a difference between the radio wave distribution in the heating chamber and the heating distribution of the object to be heated by the frequency and the phase difference in the model shown in FIG. 48.

FIG. 50 is a schematic front view of a configuration example of a microwave heating device according to an eleventh embodiment.

FIG. 51 is a view for explaining a difference in a heating distribution of an object to be heated by a frequency and a phase difference.

FIG. 52 is a view for explaining a difference in a heating distribution of an object to be heated by a frequency and a phase difference.

FIG. 53 is a view of a heating distribution of the object to be heated in a case of the phase difference 0° and the frequency 2400 MHz shown in FIG. 52.

FIG. 54 is a view for explaining a difference in a heating distribution of an object to be heated by a frequency and a phase difference.

FIG. 55 is a view of a heating distribution of the object to be heated in a case of the phase difference 0° and the frequency 914 MHz shown in FIG. 54.

FIG. 56 is a schematic front view of a configuration example of a microwave heating device according to a twelfth embodiment.

FIG. 57 is a schematic side view of a configuration example of a microwave heating device according to a thirteenth embodiment.

### DETAILED DESCRIPTION

Embodiments will be described below in detail with reference to the drawings as appropriate. However, description more detailed than necessary may be omitted. For example, a detailed description of a well-known matter and a repeated description of substantially the same configuration may be omitted. This is to avoid unnecessary redundancy of the following description and to facilitate understanding of those skilled in the art. The inventor(s) provides the accompanying drawings and the following description in order for those skilled in the art to fully understand the present disclosure, and does not intend to limit the subject matter described in the claims by these.

### 1. Embodiments

### 1.1 First Embodiment

### 1.1.1 Configuration

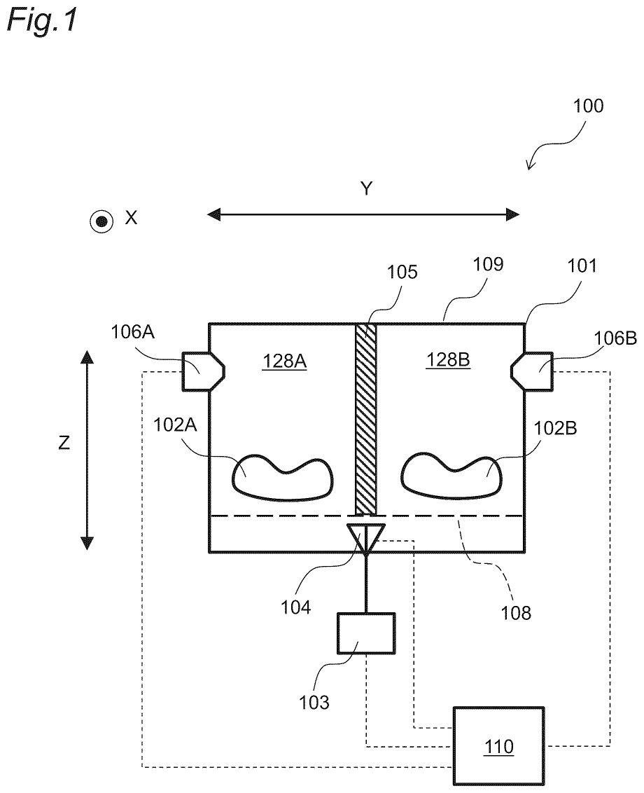

FIG. 1 is a schematic front view of a configuration example of a microwave heating device 100 according to the first embodiment. The microwave heating device 100 is a microwave processing device such as a microwave oven, for example. The microwave heating device 100 shown in FIG. 1 includes a heating chamber 101, a microwave generator 103, a microwave radiator 104, a divider 105, sensors 106A and 106B, and a control unit 110.

The heating chamber 101 forms a space for accommodating objects 102A and 102B to be heated, and is made of a material that shields radio waves. The heating chamber 101 has a cuboid box shape that stores the objects 102A and 102B to be heated, for example. FIG. 1 illustrates directions regarding the heating chamber 101 as a depth direction X, a width direction Y, and a height direction Z. The heating chamber 101 includes, for example, a left wall surface, a right wall surface, a bottom surface 108, a top surface 109, and a back surface made of a material that shields radio waves, and an opening and closing door that opens and closes for storing the objects 102A and 102B to be heated, and is configured to confine microwaves radiated from the microwave radiator 104 in the heating chamber 101. Thus, the heating chamber 101 is made of a material that shields radio waves, and can form a closed space when the objects 102A and 102B to be heated are heated. In the present disclosure, “shielding” means attenuating energy of radio waves by reflection, absorption, multiple reflection, or the like. Accordingly, the material that shields radio waves may be any material that can give such an action of “shielding”. Examples of the material that shields radio waves include a material that reflects radio waves, such as a metal material, and a material that absorbs radio waves, such as ferrite rubber.

The microwave generator 103 is a microwave generator that generates microwaves for dielectric heating of the objects 102A and 102B to be heated. The microwave generator 103 generates microwaves using, for example, a magnetron or a semiconductor transmitter. Hereinafter, in all the embodiments, the microwave generator may be a magnetron or a semiconductor oscillator. The frequency of the microwaves is, for example, 300 MHz to 1000 GHz. By irradiating a dielectric with microwaves of such frequency, dielectric loss occurs in the dielectric, and heat is generated in the dielectric. Due to this, the dielectric can be heated. In the present embodiment, the microwave generator 103 is operable by a commercial alternate current power source, and generates microwaves based on alternate current power from the commercial alternate current power source.

The microwave radiator 104 is a member that radiates microwaves generated by the microwave generator 103 to the heating chamber 101. The microwave radiator 104 includes, for example, a waveguide and a rotation antenna (not illustrated). The configuration including the waveguide and the rotation antenna may be applied to all the embodiments below. In the present embodiment, the microwave radiator 104 is disposed below the bottom surface 108 of the heating chamber 101, and radiates microwaves into the heating chamber 101 through the bottom surface 108 made of a material that transmits microwaves. The microwave radiator 104 radiates microwaves to each of divided chambers 128A and 128B described later, for example.

The divider 105 is a member for dividing the heating chamber 101 into a plurality of the divided chambers 128A and 128B. The divider 105 shown in FIG. 1 extends along the height direction Z from the bottom surface 108 to the top surface 109 of the heating chamber 101 so as to divide the heating chamber 101 in the width direction Y. The heating chamber 101 is divided into the two divided chambers 128A and 128B by the divider 105. In the example shown in FIG. 1, the object 102A to be heated is disposed in the lower divided chamber 128A, and the object 102B to be heated is disposed in the upper divided chamber 128B. The divider 105 is fixed to an inner wall of the heating chamber 101, for example, and is not detachable. The divider 105 is made of, for example, a radio wave shielding material such as metal or a radio wave transmitting material such as a dielectric.

The sensors 106A and 106B are sensors for detecting an interior state of the heating chamber 101. In the present embodiment, the heating chamber 101 is provided with the two sensors 106A and 106B. The sensor 106A is disposed in the divided chamber 128A, and the sensor 106B is disposed in the divided chamber 128B. The sensors 106A and 106B are infrared sensors, for example, and detect temperature of the respective objects 102A and 102B to be heated disposed in the heating chamber 101. The sensor 106A detects the temperature of the object 102A to be heated, and the sensor 106B detects the temperature of the object 102B to be heated. Information on the temperature detected by the sensors 106A and 106B is transmitted to the control unit 110.

The control unit 110 is a member that controls the operation of the microwave heating device 100. The control unit 110 is configured to include a microcomputer, for example. The control unit 110 is electrically connected to each constituent element of the microwave heating device 100, and controls the operation of each constituent element. In FIG. 1, electrical connection between the control unit 110 and other constituent elements is indicated by dotted lines, but the dotted lines and the control unit are omitted in the following drawings. The control unit 110 shown in FIG. 1 is electrically connected to, for example, the microwave generator 103, the microwave radiator 104, and the sensors 106A and 106B.

### 1.1.2 Operation

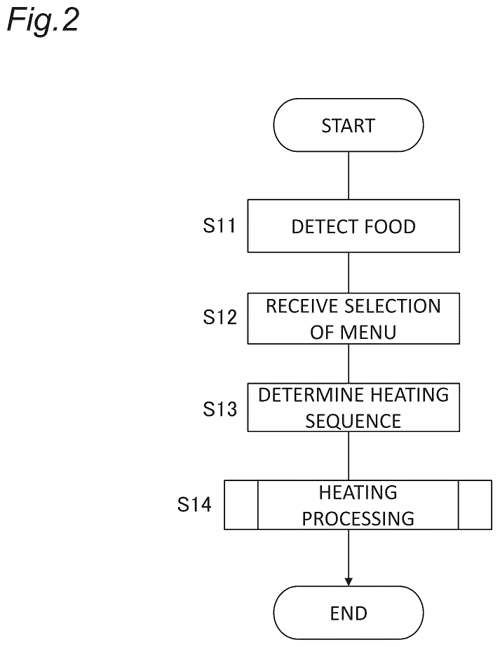

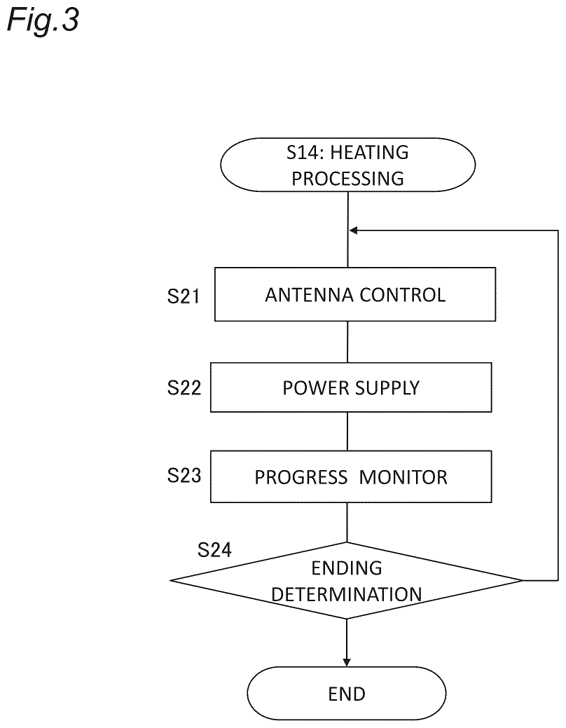

The operation of the control unit 110 of the heating device 100 shown in FIG. 1 will be described with reference to the flowcharts shown in FIGS. 2 and 3.

As shown in FIG. 2, the control unit 110 detects a food corresponding to the objects 102A and 102B to be heated based on detection results of the sensors 106A and 106B (S11), receives user's selection of a menu (S12), determines a heating sequence based on the selected menu (S13), and executes heating processing in accordance with the determined heating sequence (S14). The flowchart regarding the heating processing in step S14 is shown in FIG. 3.

As shown in FIG. 3, the control unit 110 controls rotation of the rotation antenna of the microwave radiator 104 (S21), generates microwaves by driving the microwave generator 103, supplies microwave power to the heating chamber 101 via the rotation antenna of the microwave radiator 104 (S22), acquires the detection results of the sensors 106A and 106B, monitors the progress regarding heating states of the objects 102A and 102B to be heated (S23), and determines whether or not to end the heating processing based on the result of the progress monitored in step S23 (S24). When it is determined not to end the heating processing (NO in S24), the process returns to step S21. When it is determined to end the heating processing (YES in S24), the heating processing in step S14 is ended.

### 1.1.3 Actions and Effects

The microwave heating device 100 of the first embodiment described above includes the heating chamber 101 that accommodates the objects 102A and 102B to be heated, the microwave generator 103 that generates microwaves, the microwave radiator 104 that radiates the microwaves generated by the microwave generator 103 into the heating chamber 101, and the divider 105 that divides a space in the heating chamber 101 into the divided chambers 128A and 128B. According to this configuration, by dividing the heating chamber 101 into the plurality of divided chambers 128A and 128B, it is possible to change a heating condition for each of the objects 102A and 102B to be heated by making a supply mode of the microwaves radiated to each of the divided chambers 128A and 128B different from each other. This enables heating processing more suitable for the objects 102A and 102B to be heated.

The heating chamber 101 is divided into the two divided chambers 128A and 128B. According to this configuration, by putting the objects 102A and 102B to be heated in the divided chambers 128A and 128B, respectively, it becomes possible to change the heating condition for each of the objects 102A and 102B to be heated. Furthermore, conventional equipment requires heating, one by one, of the objects 102A and 102B to be heated, but it becomes possible to simultaneously heat the plurality of objects 102A and 102B to be heated. By heating the objects 102A and 102B to be heated that are put in the divided chambers 128A and 128B equivalent in size to the objects 102A and 102B to be heated among the divided chambers 128A and 128B, highly efficient heating becomes possible. This makes it possible to select a heating source suitable for each of the objects 102A and 102B to be heated, and to achieve simultaneous heating of two items, short-time and high-temperature heating, and energy-saving heating. It is effective if the divided chambers 128A and 128B in which the objects 102A and 102B to be heated are put are smaller in size than the heating chamber 101 before division, and therefore, it is effective even if the divided chambers 128A and 128B are not equivalent in size to the objects 102A and 102B to be heated. The divider 105 is not limited to the case where the heating chamber 101 is divided into the two divided chambers 128A and 128B, and may be divided into at least two (three or more) divided chambers.

The heating chamber 101 is divided in the width direction Y. According to this configuration, dividing the heating chamber 101 in the width direction Y enables heating of multiple items, and formation of the divided chambers 128A and 128B without limiting dimensions of the objects 102A and 102B to be heated in the height direction Z or the depth direction X. This can mitigate dimensional restriction of the objects 102A and 102B to be heated that can be heated. The present configuration is particularly effective when the objects 102A and 102B to be heated have a large dimension in the height direction Z such as a tall cup.

The divided chambers 128A and 128B are provided with the sensors 106A and 106B, respectively. According to this configuration, heating suitable for a change in the heating state of the objects 102A and 102B to be heated is enabled by changing the heating condition by microwaves and other heat sources or ending heating processing based on sensing results of the sensors 106A and 106B disposed in the respective divided chambers 128A and 128B. This can achieve uniform heating and heating end detection (heating at an appropriate temperature).

Infrared sensors are used as the sensors 106A and 106B. According to this configuration, by detecting the surface temperature of the objects 102A and 102B to be heated, it becomes possible to change the heating condition in accordance with the temperature change of the objects 102A and 102B to be heated due to heating or to end the heating processing. By detecting the initial temperature of the surface of the objects 102A and 102B to be heated before heating, it becomes possible to set the heating condition in conformity to the initial temperature. This can achieve uniform heating, heating at an appropriate temperature (mitigation of overheating and insufficient heating), and automatic cooking. The sensors 106A and 106B are not limited to infrared sensors, and any type of sensors such as a humidity sensor that detects humidity, a color sensor that detects color, and a microwave sensor that detects an incident wave or a reflected wave of a microwave may be used.

The microwave radiator 104 radiates microwaves from the bottom surface 108 of the heating chamber 101 to the heating chamber 101. According to this configuration, by feeding microwaves from the bottom surface 108 of the heating chamber 101, it becomes possible to cause the microwaves to be strongly incident from below the objects 102A and 102B to be heated. Therefore, the temperature of a lower part can be increased particularly in heating of liquid, and upward convection is generated in the objects 102A and 102B to be heated, and improvement of heating efficiency and reduction of uneven heating can be achieved. Since lower parts of the objects 102A and 102B to be heated are in contact with a dish or the like, heat transfer is generated from the objects 102A and 102B to be heated to the dish or the like at the time of heating to room temperature or more, and therefore the temperature of the lower parts of the objects 102A and 102B to be heated tend to decrease. Therefore, by feeding the objects 102A and 102B to be heated with microwaves from below, the temperature of the lower parts of the objects 102A and 102B to be heated can be further increased. This can achieve high-efficiency heating, short-time cooking, and uniform heating.

The divider 105 is fixed to the heating chamber 101. According to this configuration, higher shielding performance can be achieved when the divider 105 and the inner wall of the heating chamber 101 are made of metal to shield microwaves. By fixing the divider 105 so as to disable removal of the divider 105, it becomes possible to reduce a deformation risk of the radio wave shielding structure due to removal of the divider 105. This can achieve improvement of the shielding performance and stabilization of the shielding performance. When the divider 105 is fixed to the heating chamber 101, the divider 105 and the inner wall of the heating chamber 101 are electrically conducted to each other. The interval at the fixed part needs to be shorter than a half of a microwave wavelength in the direction (depth direction X) of the side of the divider 105. In practice, the fixing may be performed at an interval shorter than ¼ of the microwave wavelength in consideration of occurrence of a case where the fixing is partially insufficient.

The microwave heating devices of the second and subsequent embodiments may achieve similar actions and effects to the above-described actions and effects. In the following description, description of actions and effects overlapping with those of the first embodiment will be omitted as appropriate.

### 1.2 Second Embodiment

### 1.2.1 Configuration

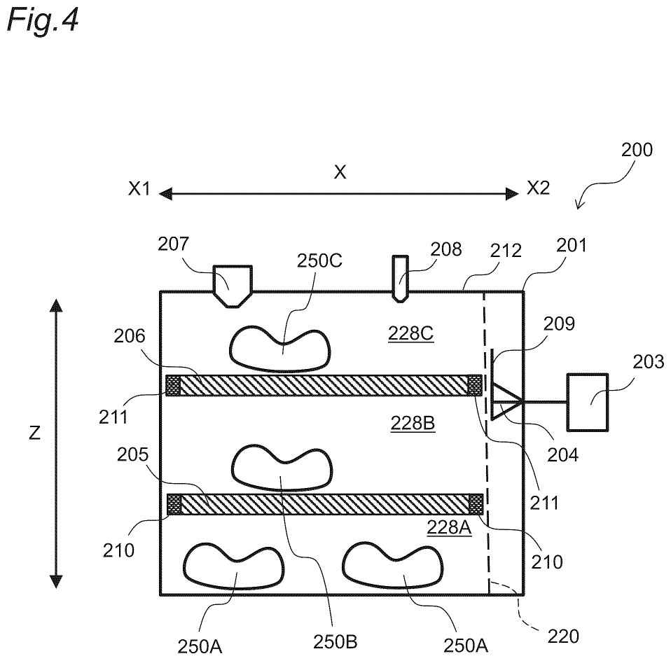

FIG. 4 is a schematic side view of a configuration example of a microwave heating device 200 according to the second embodiment. The microwave heating device 200 shown in FIG. 4 includes a heating chamber 201, a microwave generator 203, a microwave radiator 204, dividers 205 and 206, a camera 207, a vapor sensor 208, and a control unit 211.

The heating chamber 201 shown in FIG. 4 is divided in the height direction Z by two dividers 205 and 206 to form three divided chambers 228A, 228B, and 228C. As shown in FIG. 4, two objects 250A to be heated are disposed in the lower divided chamber 228A, one object 250B to be heated is disposed in the middle divided chamber 228B, and one object 250C to be heated is disposed in the upper divided chamber 228C.

The microwave radiator 204 is provided on a back side of a back surface 220 of the heating chamber 201. The microwave radiator 204 radiates, toward the heating chamber 201, microwaves from the back surface 220 made of a material that transmits microwaves. The microwave radiator 204 includes a rotation antenna 209. The rotation antenna 209 has an opening through which microwaves are radiated, and has a rotation function. The rotation antenna 209 having a rotation function can change an opening position and a radiation direction in which microwaves are radiated. The rotation antenna 209 radiates microwaves to each of the middle divided chamber 228B and the upper divided chamber 228C, for example. The rotation antenna 209 radiates microwaves to the divided chamber 228B in a first rotation range, for example, and radiates microwaves to the divided chamber 228C in a second rotation range.

The camera 207 is a sensor that images an inside of the heating chamber 201. The camera 207 is provided, for example, on a top surface 212 of the heating chamber 201, and images the upper divided chamber 228C. The vapor sensor 208 is a sensor that detects vapor in the heating chamber 201. The vapor sensor 208 is provided, for example, on a top surface 212 of the heating chamber 201, and detects vapor present in the upper divided chamber 228C. For example, the camera 207 is provided on a front surface side X1, and the vapor sensor 208 is provided on a back surface side X2, but they may be disposed at any positions.

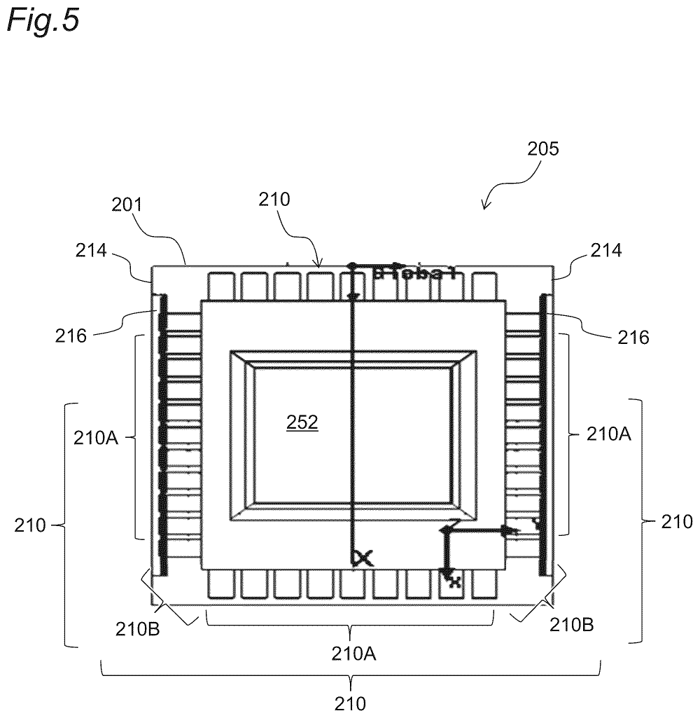

The dividers 205 and 206 are made of, for example, metal for shielding microwaves, and have radio wave shielding structures 210 and 211, respectively, at end parts thereof. Here, the radio wave shielding structures 210 and 211 will be described with reference to FIGS. 5 to 7. The radio wave shielding structures 210 and 211 have similar structures, and the radio wave shielding structure 210 of the divider 205 will be described as a representative in FIGS. 5 to 7.

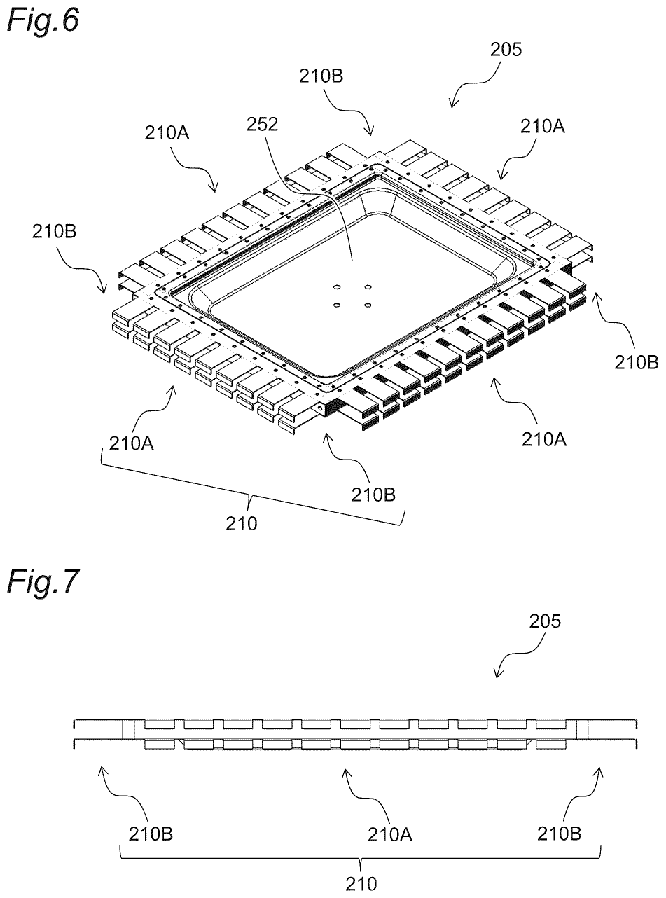

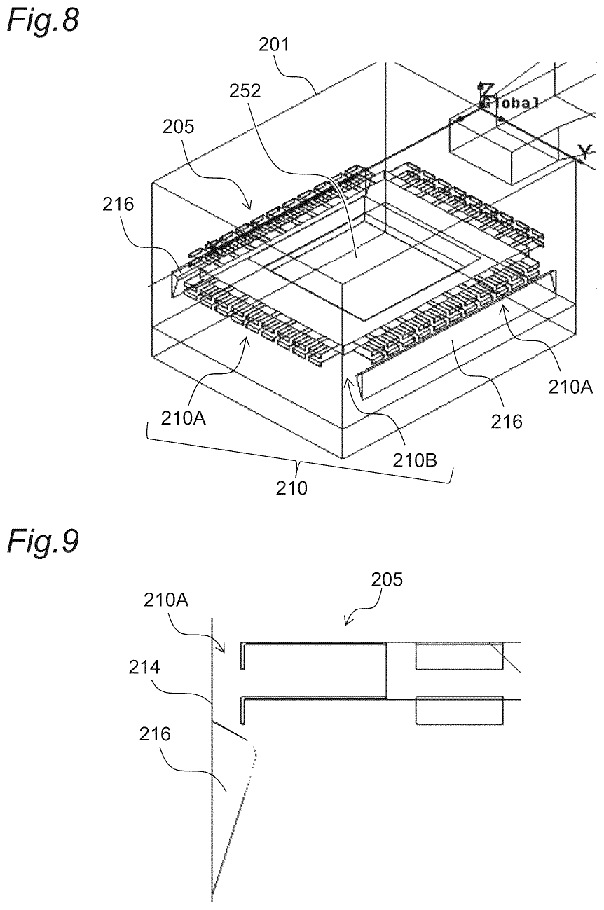

FIG. 5 is a top view of the heating chamber 201 including the divider 205, FIG. 6 is a perspective view of the divider 205, and FIG. 7 is a side view of the divider 205. FIG. 8 is a schematic perspective view of the heating chamber 201 including the divider 205, and FIG. 9 is a schematic front view showing a location where the divider 205 and an inner wall 214 of the heating chamber 205 come close to each other.

As shown in FIGS. 5 and 6, the divider 205 has, at its center part, a placement surface 252 for placing the object 250B to be heated. The divider 205 includes the radio wave shielding structures 210 on four sides. The radio wave shielding structure 210 includes a radio wave shielding structure 210A provided in a straight part of the divider 205 and a radio wave shielding structure 210B provided at a corner part of the divider 205. The radio wave shielding structure 210A has a plurality of choke structures regularly arranged in a line, for example. The radio wave shielding structure 210B has a structure different from that of the radio wave shielding structure 210A, and has, for example, a structure in which a choke structure at an end in a first row and a choke structure at an end in a second row adjacent to the first row are arranged at an interval. As shown in FIG. 5, the four sides of the divider 205 are provided with the radio wave shielding structures 210A, and the four corners of the divider 205 are provided with the radio wave shielding structures 210B. This shields microwaves on the entire circumference of the divider 205, and prevents transmission of microwaves between the plurality of divided chambers. As shown in FIGS. 6 and 7, two of the radio wave shielding structures 210 are provided. This improves the microwave shielding performance as compared with the case of providing one radio wave shielding structure 210.

As shown in FIGS. 5 and 8, the inner wall 214, which is an inner surface of the heating chamber 201, is provided with a rail 216. The rail 216 supports the divider 205 from below, and positions the divider 205 at a predetermined position inside the heating chamber 201. The divider 205 may be placed on the rail 216, and is configured to be detachable from the heating chamber 201. This enables selection of the heating processing of the object to be heated in a state where the divider 205 is disposed in the heating chamber 201, or the heating processing of the object to be heated in a state where the divider 205 is not disposed in the heating chamber 201.

As shown in FIG. 9, the radio wave shielding structure 210A is a non-contact choke structure that does not come into contact with an upper surface of the rail 216. The divider 205 is supported in contact with the inner wall 214 of the heating chamber 201 at a location different from the radio wave shielding structure 210A.

The rail 216 is made of an insulator such as resin or rubber, for example. When both the radio wave shielding structure 210A and the inner wall 214 of the heating chamber 201 are made of metal, the rail 216 as an insulator is provided therebetween, thereby increasing insulation resistance. The rail 216 is not limited to an insulator, and may be made of metal, and in that case, another insulator may be provided between the radio wave shielding structure 210A and the rail 216.

### 1.2.2 Actions and Effects

According to the microwave heating device 200 of the second embodiment described above, the three divided chambers 228A to 228C are provided. According to this configuration, variations of heating conditions can be increased as compared with the case of two divided chambers, and more flexible heating processing becomes possible.

The dividers 205 and 206 are made of metal. According to this configuration, microwaves, hot air, and steam do not transmit the metal. Therefore, the degree of heating by the heating sources of microwave, hot air, and steam can be changed for each of the divided chambers 228A to 228C. By dividing the heating chamber 201, it becomes possible to heat food by microwave heating, hot air heating, or steam heating in a small space, and highly efficient heating becomes possible. It is possible to select a heating source suitable for each of the objects 250A to 250C to be heated, and to achieve simultaneous heating of multiple items, short-time and high-temperature heating, and energy-saving heating. Typical examples of metal include stainless steel, aluminum, aluminum-plated steel plate, and galvanized steel plate. It is also possible to transmit only hot air and steam by providing the dividers 205 and 206 with a gap (hole, slit, or the like) that does not let microwaves transmit.

An insulator (rail 216) is provided between the divider 205 and the inner wall 214 of the heating chamber 201. According to this configuration, by providing the insulator between metals, it becomes possible to increase insulation resistance, and it is possible to reduce the possibility of discharge even when a strong electric field is generated between metals during microwave heating. It becomes possible to keep the distance between the metals at a certain degree or more by the insulator, it is possible to further reduce the possibility of discharge. This can achieve improvement of safety (reduction of the possibility of discharge). Typical examples of insulator include resin, rubber, and wood.

The heating chamber 201 is divided in the height direction Z. According to this configuration, dividing the heating chamber 201 in the height direction Z enables heating of multiple items, and furthermore, formation of the divided chambers 228A to 228C without limiting dimensions in the width direction Y or the depth direction X of the objects 250A to 250C to be heated. This can achieve simultaneous heating of multiple items, and mitigate dimensional restriction of the objects 250A to 250C to be heated that can be heated. The present configuration is particularly effective when the objects 250A to 250C to be heated have a low height but a large area on a horizontal plane such as a lunch box.

The dividers 205 and 206 have the placement surface 252 on which the objects 250B and 250C to be heated are placed. According to this configuration, it is possible to give each of the dividers 205 and 206 a function of dividing the heating chamber 201 and a function of placing the objects 250B and 250C to be heated, and it becomes possible to reduce the number of components. This can achieve simplification of the configuration (improvement in usability and cleanability) and cost reduction.

The divided chamber 228C includes the vapor sensor 208. According to this configuration, by the vapor sensor 208 installed in the divided chamber 228C detecting the vapor generated from the object 250C to be heated, it is possible to determine that the temperature of the object 250C to be heated has increased, and it becomes possible to change the heating condition and to end the heating processing. This can achieve uniform heating, heating at an appropriate temperature (mitigation of overheating and insufficient heating), and automatic cooking. When provided, the vapor sensor may be provided in each of the divided chambers 228A to 228C, and may be provided in at least one of the divided chambers 228A to 228C.

The divided chamber 228C includes the camera 207. According to this configuration, by the camera 207 installed in the divided chamber 228C detecting the shape or the color of the surface of the object 250C to be heated, it becomes possible to determine the progress degree of heating of the object 250C to be heated, change the heating condition, and end the heating processing. By detecting the shape or the color of the surface of the object 250C to be heated before heating is started, it becomes possible to set the heating condition in conformity to the initial temperature. This can achieve uniform heating, heating at an appropriate temperature (mitigation of overheating and insufficient heating), and automatic cooking. When provided, the camera may be provided in each of the divided chambers 228A to 228C, and may be provided in at least one of the divided chambers 228A to 228C.

In the second embodiment, the same divided chamber 228C is provided with the camera 207 and the vapor sensor 208 as two types of sensors, but the present invention is not limited to such case, and the different divided chambers 228A to 228C may be provided with different types of sensors, respectively. Specifically, the divided chamber may include a first divided chamber and a second divided chamber, the first divided chamber may be provided with a first sensor, and the second divided chamber may be provided with a second sensor that is a different type of the first sensor. According to this configuration, temperature change of the object to be heated by heating varies depending on the type of the object to be heated. Depending on the type of the object to be heated, the temperature difference between the inside and the surface wave of the object to be heated, the amount of vapor coming out of the object to be heated, the shape change of the object to be heated due to heating, and the change in color of the surface of the object to be heated due to temperature increase vary. Therefore, the type of sensor that more accurately detects the heating state of the object to be heated varies depending on the type of the object to be heat. Therefore, by providing the plurality of divided chambers with different types of sensors, if a divided chamber in which the object to be heated is disposed is selected in accordance with the type of the object to be heated, it becomes possible to more accurately detect the heating state of the object to be heated, change the heating condition, and end the heating processing. This can achieve uniform heating, heating at an appropriate temperature (mitigation of overheating and insufficient heating), and automatic cooking.

The microwave radiator 204 radiates microwaves from the back surface 220 of the heating chamber 201 to the heating chamber 201. According to this configuration, the shape in a front-rear direction (depth direction X) of the heating chamber 201 and the permittivity of the constituent elements are greatly different, but the shape of the side surface and the constituent elements are often substantially equivalent. Therefore, standing wave distribution in the heating chamber 201 becomes substantially bilaterally symmetrical, when the bilaterally symmetrical objects 250A to 250C to be heated are placed at the center in the right-left direction of the heating chamber 201, heating distribution of the objects 250A to 250C to be heated becomes bilaterally symmetrical. However, due to the symmetry of the shape and the constituent elements of the heating chamber 201, the heating distribution in the front-rear direction and the up-down direction (height direction Z) does not often become symmetrical. Therefore, by providing the back surface 220 of the heating chamber 201 with the microwave radiator 204, and controlling the directivity of the microwaves to be radiated from the microwave radiator 204 to the heating chamber 201 in the up-down direction, it is possible to uniform the heating distribution in the up-down direction of the objects 250A to 250C to be heated. This can achieve uniform heating.

The microwave radiator 204 includes the rotation antenna 209. According to this configuration, by controlling the directivity of the microwaves to be radiated to the heating chamber 201 or the divided chambers 228A to 228C by the rotation antenna 209, it becomes possible to change the standing wave distribution in the heating chamber 201 or the divided chambers 228A to 228C. Therefore, control of the heating distribution of the objects 250A to 250C to be heated becomes possible, and uniform heating can be achieved.

The dividers 205 and 206 are detachable from the inner wall 214 of the heating chamber 201. According to this configuration, an object to be heated having a dimension that allows the object to be put in the heating chamber 201 becomes heatable. It becomes easy to perform cleaning by removing the dividers 205 and 206. This can improve the cleanability, form a divided chamber corresponding to the size of an object to be heated, and mitigate dimensional restriction of the object to be heated that can be heated.

The dividers 205 and 206 are provided with the radio wave shielding structures 210 and 211 of both directions. According to this configuration, it becomes possible to concentrate microwaves in each of the divided chambers 228A to 228C that radiate microwaves. Reduction of microwaves propagating from one divided chamber to another divided chamber makes setting of cooking conditions easy, and enables control so that the objects 250A to 250C to be heated not desired to be applied with microwaves, for example, are not applied with microwaves. This can achieve concentrated heating.

The four sides of the dividers 205 and 206 are provided with the radio wave shielding structures 210 and 211. According to this configuration, the radio wave shielding performance of the dividers 205 and 206 is improved.

The corner part and a part other than the corner part in the divider 205 are provided with the radio wave shielding structures 210A and 210B different from each other. According to this configuration, the electric field distribution is often different between the corner part and a part (straight part) other than the corner part in the divider 205. Specifically, a periphery of the corner part is greatly affected by microwaves reflected by the inner wall of the adjacent heating chamber 201, and microwaves propagate in a direction parallel to the side in the radio wave shielding structure 210 on the side of the adjacent divider 205, and therefore microwaves having propagated in parallel to the two sides interfere with each other, resulting in an electric field distribution different from that of the straight part. Therefore, the optimum shape of the radio wave shielding structure 210 is different between the straight part and the periphery of the corner part. Due to this, by providing the corner part and the part other than the corner part with the different radio wave shielding structures 210A and 210B, it is possible to achieve improvement of the shielding performance.

The radio wave shielding structures 210 and 211 are non-contact chokes. According to this configuration, use of the non-contact shielding structure makes removal of the dividers 205 and 206 easy. As compared with a case of a contact shielding structure, it is no longer necessary to reliably bring the inner wall of the heating chamber 201 and the metals of the dividers 205 and 206 into contact with each other, and the configuration can be simplified. This makes removal of the dividers 205 and 206 easy, and can achieve improvement of cleanability. It is possible to prevent leakage of microwaves from a part where the inner wall of the heating chamber 201 and the metals of dividers 205 and 206 are not in contact with each other, and reduce the possibility of discharge.

### 1.2.3 Modification of Radio Wave Shielding Structure

### 1.2.3.1 Configuration

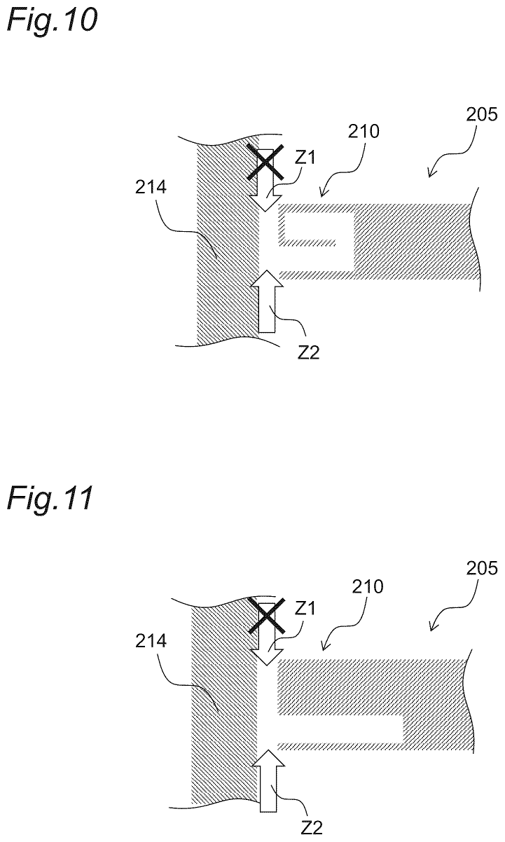

Here, a modification of the radio wave shielding structure 210 will be described with reference to FIGS. 10 to 17. FIGS. 10 to 17 are schematic cross-sectional views of a microwave shielding structure between the radio wave shielding structure 210 and the inner wall 214 of the heating chamber 201.

The radio wave shielding structure 210 according to the first modification has the cross-sectional shape shown in FIG. 10 and shields radio waves of one direction. The radio wave shielding structure 210 shown in FIG. 10 shields microwaves entering a downward direction Z1, but does not shield microwaves entering an upward direction Z2.

The radio wave shielding structure 210 according to the second modification has the cross-sectional shape shown in FIG. 11 and shields radio waves of one direction. The radio wave shielding structure 210 shown in FIG. 11 shields microwaves entering the downward direction Z1, but does not shield microwaves entering the upward direction Z2.

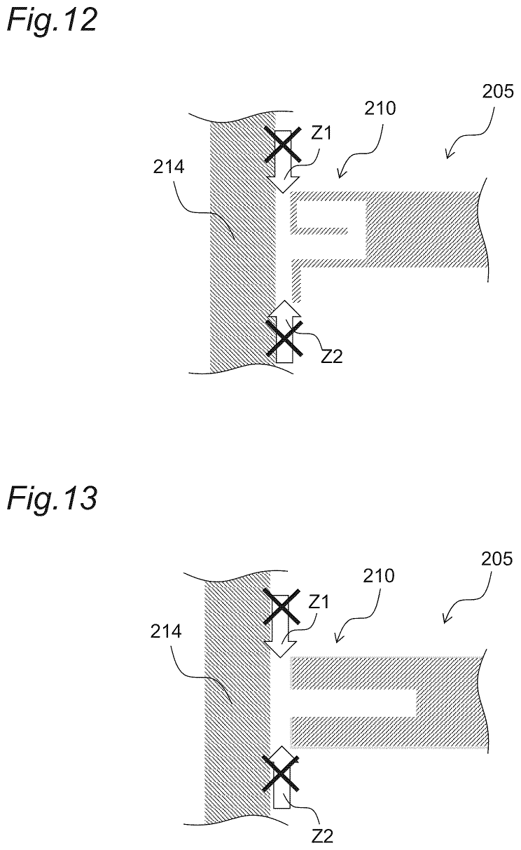

The radio wave shielding structure 210 according to the third modification has the cross-sectional shape shown in FIG. 12 and shields radio waves of both directions. The radio wave shielding structure 210 shown in FIG. 12 shields microwaves entering the downward direction Z1 and shields microwaves entering the upward direction Z2.

The radio wave shielding structure 210 according to the fourth modification has the cross-sectional shape shown in FIG. 13 and shields radio waves of both directions. The radio wave shielding structure 210 shown in FIG. 13 shields microwaves entering the downward direction Z1 and shields microwaves entering the upward direction Z2.

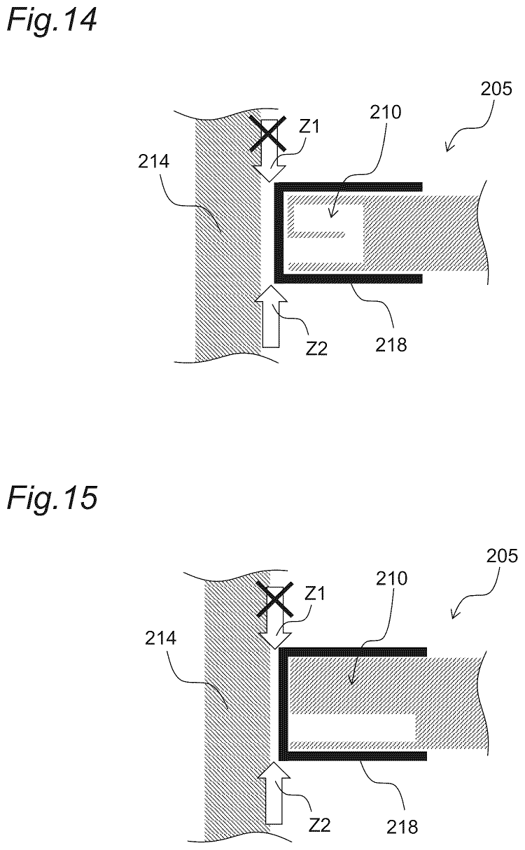

As shown in FIG. 14, the radio wave shielding structure 210 according to the fifth modification has a similar shape to that of the radio wave shielding structure 210 (FIG. 10) of the first modification, and is a radio wave shielding structure of one direction. The radio wave shielding structure 210 shown in FIG. 14 further includes a dielectric cover 218.

As shown in FIG. 15, the radio wave shielding structure 210 according to the sixth modification has a similar shape to that of the radio wave shielding structure 210 (FIG. 11) of the second modification, and is a radio wave shielding structure of one direction. The radio wave shielding structure 210 shown in FIG. 15 further includes the dielectric cover 218.

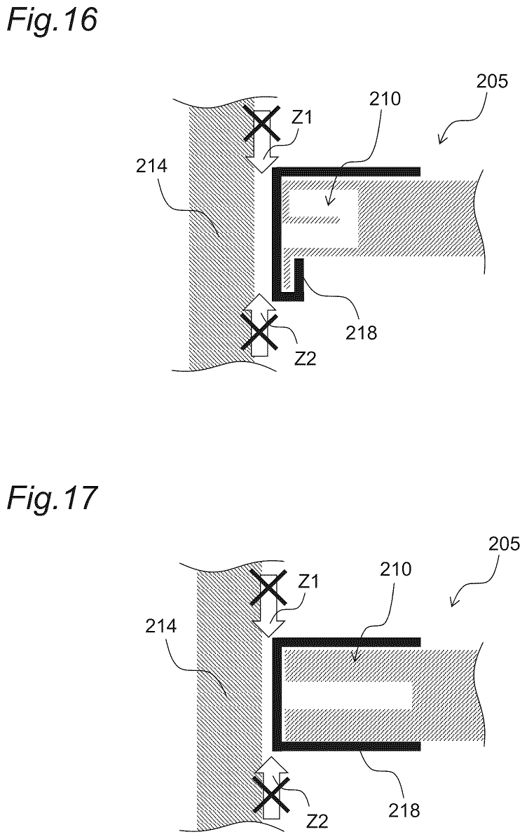

As shown in FIG. 16, the radio wave shielding structure 210 according to the seventh modification has a similar shape to that of the radio wave shielding structure 210 (FIG. 12) of the third modification, and is a radio wave shielding structure of both directions. The radio wave shielding structure 210 shown in FIG. 16 further includes the dielectric cover 218.

As shown in FIG. 17, the radio wave shielding structure 210 according to the eighth modification has a similar shape to that of the radio wave shielding structure 210 (FIG. 13) according to the fourth modification, and is a radio wave shielding structure of both directions. The radio wave shielding structure 210 shown in FIG. 17 further includes the dielectric cover 218.

### 1.2.3.2 Actions and Effects

According to the first, second, fifth, and sixth modifications, the divider 205 includes the radio wave shielding structure 210 of one direction. According to this configuration, for example, in a non-contact radio wave shielding structure, the radio wave shielding performance greatly differs depending on the distance in which the metal faces from the divided chamber 205 to entry into a resonance space of the radio wave shielding structure 210. Thus, the radio wave shielding performance of the divider 205 has directionality, whereby it becomes possible to selectively use radiating microwaves to one divided chamber to propagate the microwaves to other divided chambers and concentrating microwaves into one divided chamber. This facilitates concentrated heating and enables microwave heating of a plurality of divided chambers at a time.

According to the third, fourth, seventh, and eighth modifications, the divider 205 includes the radio wave shielding structure 210 of both directions. According to this configuration, actions and effects similar to those of the second embodiment are achieved.

According to the fifth to eighth modifications, the radio wave shielding structure 210 includes the dielectric cover 218. According to this configuration, the non-contact radio wave shielding structure 210 is often configured by a metal periodic structure. The transmission length of the resonance space of the shielding structure is often an integral multiple of ¼ of the wavelength of the microwave desired to be shielded. Therefore, the radio wave shielding structure 210 has a configuration in which a metal plate is bent, and foreign matters such as food residues and water droplets may enter. When a foreign matter having a high permittivity enters, the microwave distribution in the resonance space of the radio wave shielding structure 210 changes, and there is a possibility that the shielding performance is deteriorated as compared with a normal condition free from a foreign matter. Since there is a high possibility that a strong electric field is generated between the metals of the radio wave shielding structure 210, the possibility of discharge and smoking is increased due to entry of food residues. Therefore, by disposing the dielectric cover 218 in a shielding structure with a dielectric having a low permittivity such as resin, it becomes possible to reduce the possibility of deterioration in shielding performance, discharge, and smoking. It also becomes possible to improve cleanability. This can stabilize the shielding performance (safety improvement), prevent insertion of foreign matters, reduce discharge (safety improvement), and improve insulation resistance of metal parts. By keeping the distance between the inner wall 214 of the heating chamber 201 and the radio wave shielding structure 210 at a certain degree or more, it is possible to reduce discharge (safety improvement), and improve cleanability. Typical examples of dielectric include ceramic, resin, and glass.

### 1.3 Third Embodiment

### 1.3.1 Configuration

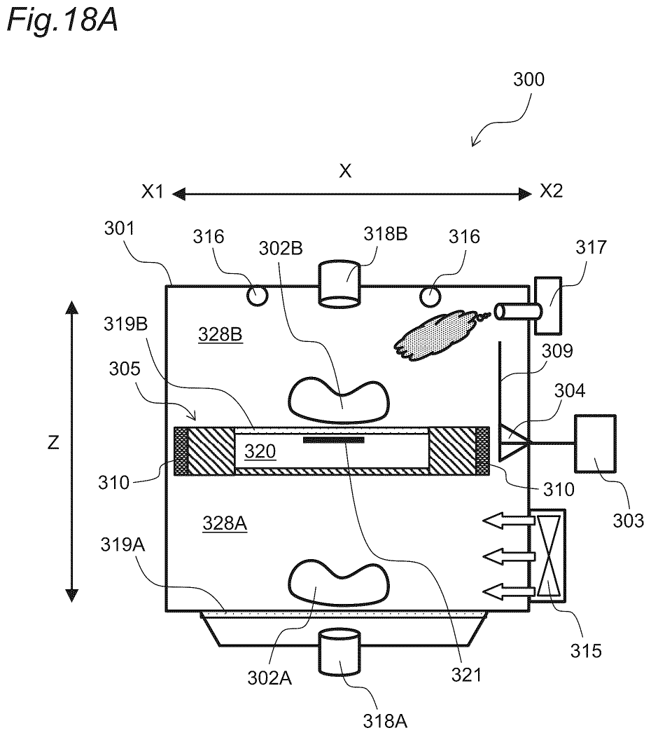

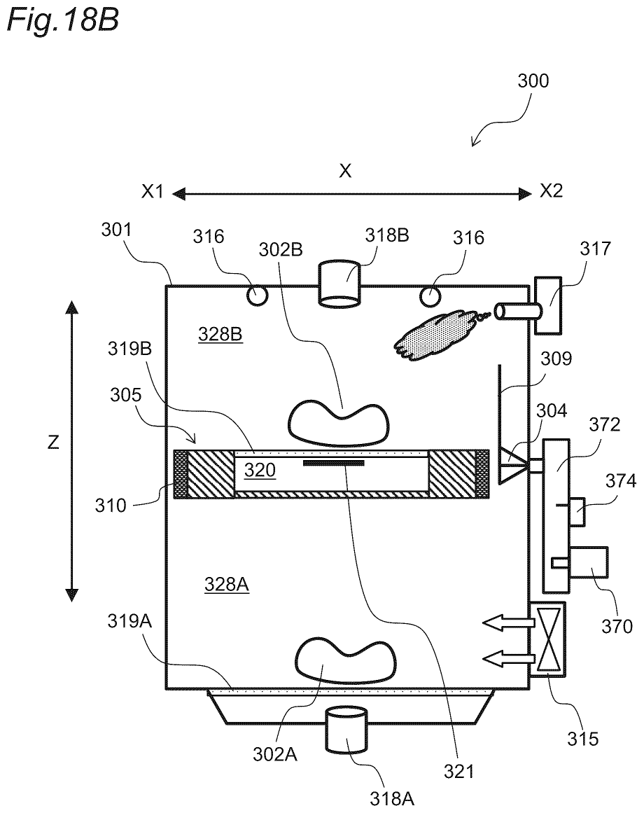

FIG. 18A is a schematic side view of a configuration example of a microwave heating device 300 according to the third embodiment. The microwave heating device 300 shown in FIG. 18A includes a heating chamber 301, a microwave generator 303, a microwave radiator 304, a divider 305, a hot air heating means 315, a radiation heating means 316, a steam heating means 317, and microwave sensors 318A and 318B.

The heating chamber 301 shown in FIG. 18A is divided in the height direction Z by the divider 305 to form two divided chambers 328A and 328B. An object 302A to be heated is disposed in the lower divided chamber 328A, and an object 302B to be heated is disposed in the upper divided chamber 328B.

The microwave radiator 304 is provided on a back surface side of the heating chamber 301, and includes a rotation antenna 309. The rotation antenna 309 radiates microwaves toward the upper divided chamber 328B, for example.

The hot air heating means 315 is a member for performing heating with hot air. The hot air heating means 315 includes, for example, a convection heater and a fan. The hot air heating means 315 is provided on the back surface side of the heating chamber 301 so as to blow hot air toward the lower divided chamber 328A, for example.

The radiation heating means 316 is a member for performing heating with radiation. The radiation heating means 316 includes, for example, an infrared heater. The radiation heating means 316 is provided on the top surface side of the heating chamber 301 so as to supply radiation heat toward the upper divided chamber 328B, for example.

The steam heating means 317 is a member for performing heating with steam. The steam heating means 317 includes, for example, a water storage unit and a heater for generating vapor. For example, the steam heating means 317 is provided on the back surface side of the heating chamber 301 so as to blow steam toward the upper divided chamber 328B.

Each of the microwave sensors 318A and 318B is a sensor that detects microwaves. The heating chamber 301 shown in FIG. 18A is provided with the two microwave sensors 318A and 318B. The microwave sensor 318A detects microwaves in the lower divided chamber 328A, and the microwave sensor 318B detects microwaves in the upper divided chamber 328B.

In the lower divided chamber 328A, the object 302A to be heated is placed on a placement surface 319A. The placement surface 319A is a plate-shaped member constituting a bottom surface of the heating chamber 1. In the upper divided chamber 328B, the object 302B to be heated is placed on a placement surface 319B. The placement surface 319B is a plate-shaped member constituting an upper surface of the divider 305. Each of the placement surfaces 319A and 319B is made of a dielectric.

The divider 305 defines a recess 320 below the placement surface 319B. A metal 321 is disposed in the recess 320. Disposing the metal 321 can change a microwave distribution around a lower part of the object 302B to be heated.

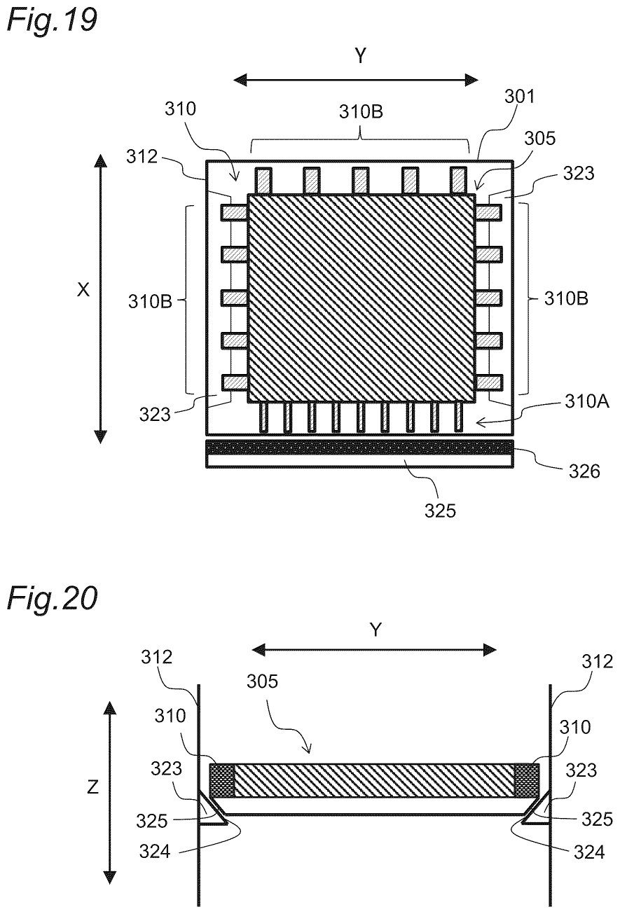

The divider 305 further includes a radio wave shielding structure 310. Details of the radio wave shielding structure 310 will be described with reference to FIGS. 19 and 20.

FIG. 19 is a top view of the divider 305, and FIG. 20 is a cross-sectional view of the divider 305 as viewed from the front side.

As shown in FIG. 19, the radio wave shielding structure 310 has two types of radio wave shielding structures 310A and 310B. The radio wave shielding structure 310A is provided on one side close to a door 325 in the divider 310 and faces door glass 326 constituting the door 325. The radio wave shielding structure 310B is provided on the three sides other than the side provided with the radio wave shielding structure 310A in the divider 310. The radio wave shielding structure 310A has a structure different from that of the radio wave shielding structure 310B, and has a pitch and a width different from those of the choke structure of the radio wave shielding structure 310B, for example.

As shown in FIGS. 19 and 20, inner walls 312 on both sides of the heating chamber 310 are provided with rails 323. The rail 323 shown in FIG. 20 has an inclination surface 324 that supports the divider 305. An inclination surface 325 corresponding to the inclination of the inclination surface 324 is formed on a lower surface of the divider 305. By bringing the inclination surface 325 of the divider 305 and the inclination surface 324 of the rail 323 into contact with each other to dispose the divider 305, it is possible to position (center) the divider 305 toward a predetermined position (center position) in the Y direction when disposing the divider 305 in the heating chamber 301.

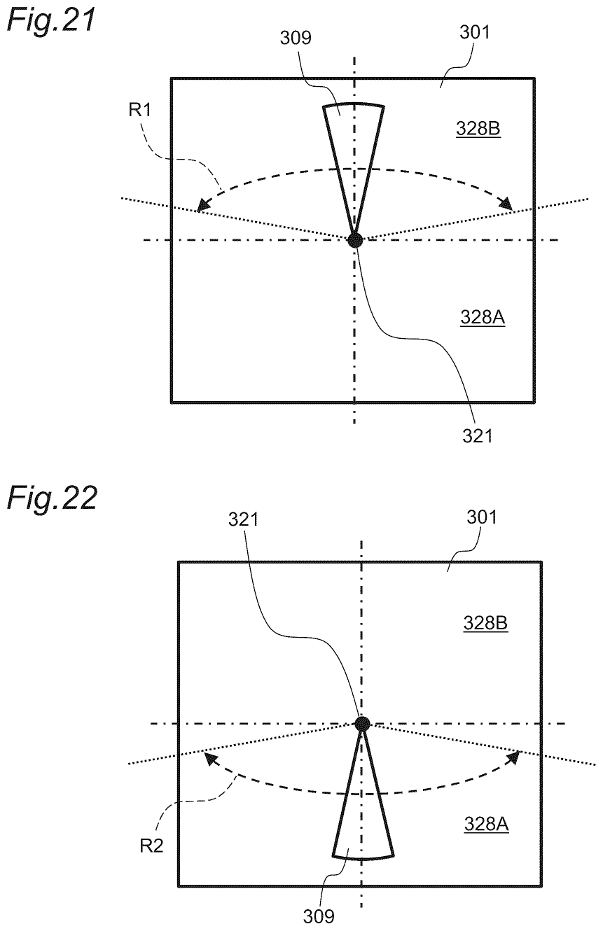

An operation example of the rotation antenna 309 shown in FIG. 18A will be described with reference to FIGS. 21 to 23.

The rotation antenna 309 shown in FIG. 21 is controlled so as to rotate within a rotation range R1 about a rotation axis 321 positioned substantially at the center of the heating chamber 301. The rotation range R1 is a range covering only the upper divided chamber 328B. The rotation antenna 309 radiates microwaves toward the upper divided chamber 328B, and does not radiate microwaves toward the lower divided chamber 328A.

The rotation antenna 309 shown in FIG. 22 is controlled so as to rotate within a rotation range R2 about the rotation axis 321 positioned substantially at the center of the heating chamber 301. The rotation range R2 is a range covering only the lower divided chamber 328A. The rotation antenna 309 radiates microwaves toward the lower divided chamber 328A, and does not radiate microwaves toward the upper divided chamber 328B.

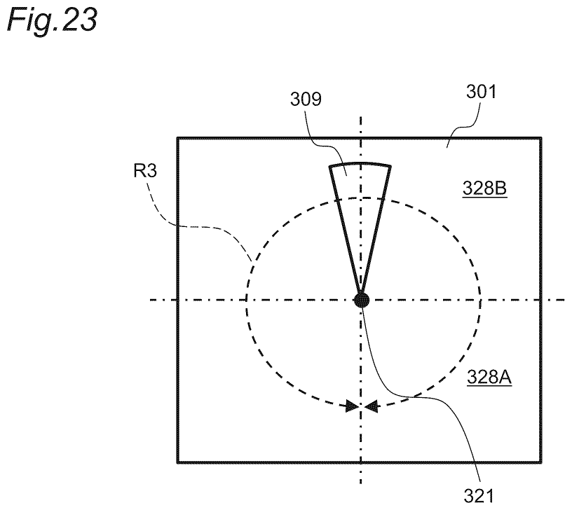

The rotation antenna 309 shown in FIG. 23 is controlled so as to rotate within a rotation range R3 about the rotation axis 321 positioned substantially at the center of the heating chamber 301. The rotation range R3 is a rotation range of 360 degrees and covers both the divided chambers 328A and 328B. The rotation antenna 309 radiates microwaves toward the lower divided chamber 328A in the first rotation range, and radiates microwaves toward the upper divided chamber 328B in the second rotation range.

### 1.3.2 Actions and Effects

The microwave heating device 300 of the third embodiment described above further includes the hot air heating means 315, the radiation heating means 316, and the steam heating means 317. According to this configuration, use of any of hot air, radiation, and steam heating in addition to microwave heating enables cooking more appropriate for the objects 302A and 302B to be heated, improvement of cooking quality, and an increase in cookable menus. For an object to be heated that needs overall temperature increase and browning of the surface such as gratin, for example, combined use of microwave heating and radiation heating is effective. For an object to be heated that needs both overall temperature increase and prevention of drying such as Chinese steamed buns, combined use of microwave heating and steam heating is effective. For an object to be heated that has a large volume and needs overall temperature increase and overall baking such as roasted beef, combined use of microwave heating and hot air heating is effective. It is not necessary to provide all of the hot air heating means 315, the radiation heating means 316, and the steam heating means 317, and at least one means may be provided in at least one divided chamber.

Only one of the plurality of divided chambers 328A and 328B has a function of heating an object to be heated (FIG. 21 and FIG. 22). According to this configuration, by putting the object to be heated into one divided chamber, it becomes possible to change the heating condition for each object to be heated. By heating an object to be heated that is put in a divided chamber equivalent in size to the object to be heated of the plurality of divided chambers 328A and 328B, highly efficient heating becomes possible. This can achieve short-time and high-temperature heating and energy-saving heating. When a plurality of objects to be heated are put in one divided chamber, similar effects can be achieved. It is effective if the divided chamber in which an object to be heated is put is smaller in size than the heating chamber 301 before division, and therefore, it is effective even if the divided chamber is not equivalent in size to the object to be heated.

The two divided chambers 328A and 328B of the plurality of divided chambers 328A and 328B have a function of heating the objects 302A and 302B to be heated (FIG. 23). According to this configuration, by putting the objects 302A and 302B to be heated in the two divided chambers 328A and 328B, respectively, it becomes possible to change the heating condition for each of the objects 302A and 302B to be heated. Furthermore, conventional equipment requires heating of the objects 302A and 302B to be heated one by one, but it becomes possible to simultaneously heat the plurality of objects 302A and 302B to be heated. By heating the objects 302A and 302B to be heated that are put in the plurality of divided chambers 328A and 328B equivalent in size to the objects 302A and 302B to be heated of the plurality of divided chambers 328A and 328B, highly efficient heating becomes possible. This makes it possible to select a heating source suitable for each of the objects 302A and 302B to be heated, and to achieve simultaneous heating of two items, short-time and high-temperature heating, and energy-saving heating. When the plurality of objects 302A and 302B to be heated are put in one of the divided chambers 328A and 328B, similar effects can be achieved. It is effective if the divided chambers 328A and 328B in which the objects 302A and 302B to be heated are put are smaller in size than the heating chamber 301 before division, and therefore, it is effective even if the divided chambers 328A and 328B are not equivalent in size to the objects 302A and 302B to be heated.

The placement surface 319B of the divider 305 is made of a dielectric, and the divider 305 defines the recess 320 below the placement surface 319B. According to this configuration, by providing the recess 320 below the placement surface 319B, it is possible to form a space that allows microwaves to come around under the object 302B to be heated. If the object 302B to be heated is placed on a metal plate, the electric field strength generated at the time of microwave heating becomes zero on the metal surface, and therefore the contact surface between the object 302B to be heated and the metal undergoes weak heating. Therefore, by providing a space below the placement surface 319B made of a dielectric, it becomes possible to enhance heating on the placement surface 319B, which is an installation surface of the object 302B to be heated. This can achieve uniform heating. Typical examples of dielectric include ceramic, resin, and glass.

The recess 320 is provided with the metal 321. According to this configuration, the metal 321 reflects microwaves, and thus the microwave distribution of the periphery becomes a microwave distribution different from that in a case without the metal 321. Therefore, it becomes possible to uniform the heating distribution of the object 302B to be heated in accordance with the shape and the placement position of the metal 321. This can achieve uniform heating. The metal 321 is effective in any of a plate shape, a block shape, and a rod shape. By making any dimension of the metal 321 an integral multiple of ¼ wavelength of a microwave, it becomes possible to cause the metal 321 to act as an antenna, and it becomes possible to more remarkably change the microwave distribution around the metal 321. Any dimension of the metal 321 refers to a dimension of one side of the metal 321 or a dimension between surfaces of the metal 321.

The rotation antenna 309 is controlled so as to rotate within a predetermined rotation range. According to this configuration, by reciprocating the rotation angle of the rotation antenna 309 within a range where microwaves are radiated to one divided chamber, it becomes possible to concentratedly heat an object to be heated in one divided chamber and to perform heating while changing a standing wave distribution in the divided chamber determined by the rotation angle, and it becomes possible to improve uniformity of heating of the object to be heated. This can concentrate microwaves on an object to be heated in a divided chamber that is targeted, and can uniformly heat the object to be heated.

The four sides of the divider 305 are provided with the radio wave shielding structure 310. According to this configuration, the radio wave shielding performance of the divider 305 is improved.

A first side of the divider 305 is provided with the radio wave shielding structure 310A (first radio wave shielding structure), and a second side different from the first side of the divider 305 is provided with the radio wave shielding structure 310B (second radio wave shielding structure) different from the radio wave shielding structure 310A. According to this configuration, the shape of the inner wall of the heating chamber 301 and the permittivity of the constituent elements are often different. For example, the door 325 side has a dielectric such as a glass plate or a resin plate, and the surface having a power feed unit has an antenna that radiates microwaves to the heating chamber 301. Therefore, the shape of the optimum shielding configuration varies depending on the difference in the shape of the inner wall 312 of the heating chamber 301 and the permittivity of the constituent elements. Thus, by designing the radio wave shielding structure 310 in accordance with the side of the divider 305, it is possible to improve the radio wave shielding performance.

The first side provided with the radio wave shielding structure 310A of the divider 305 is a side on the door 325 side in the divider 305. According to this configuration, the door glass 326 or a resin plate is often installed on a side facing the heating chamber 301 in the door 325. Wavelength compression of microwaves occurs in the dielectric, and therefore the microwave distribution between the inner wall of the heating chamber 301 and the divider 305 is different between a side on the door 325 side and a side other than the door 325 side. Therefore, when the shielding performance of the side on the door 325 side is made equivalent to the shielding performance of the other sides, the radio wave shielding structure 310A of the side on the door 325 side and the radio wave shielding structure 310B of the other sides may be different from each other. When the distance between the radio wave shielding structure 310 and the metal surface on the door 325 side is equivalent to the distance between the radio wave shielding structure 310 and the metal surface on the other sides, the microwave transmission length in the resonance space of the radio wave shielding structure 310 may be decreased in consideration of wavelength compression in the dielectric. In order to prevent mechanical interference, when the distance between the radio wave shielding structure 310 and the metal surface on the door 325 side is greater than or equal to the wavelength compression in the dielectric, the microwave transmission length in the resonance space of the radio wave shielding structure 310 may be increased. Thus, by making the radio wave shielding structure 310 of the side on the door 325 side of the divider 305 different from the radio wave shielding structures 310 on the other sides, it is possible to improve the radio wave shielding performance.

The side provided with the radio wave shielding structure 310A is not limited to the side on the door 325 side of the divider 305, and the radio wave shielding structure 310A may be provided, for example, on the side (back surface side) of a side facing the microwave radiator 304 in the divider 305. That is, the first side provided with the radio wave shielding structure 310A of the divider 305 may be a side close to the microwave radiator 304 in the divider 305. According to this configuration, the energy density of the microwave is higher in the vicinity of the microwave radiator 304, and there is a high possibility that a strong electric field is generated between the metal of the divider 305 and the rotation antenna 309 to cause discharge. Therefore, when the radio wave shielding structure of the divider 305 in the vicinity of the microwave radiator 304 has a configuration in which discharge is less likely to occur than in the radio wave shielding structure of other parts, the possibility of discharge can be reduced. The radio wave shielding structure may be made different by making the distance between, for example, the rotation antenna 309 and the radio wave shielding structure 300 longer than the distance between another inner wall 312 (side wall) of the heating chamber 301 and the radio wave shielding structure 300. It is also effective to round an end surface of each metal of the radio wave shielding structure 310 or the rotation antenna 309. It is also effective to attach an insulator to the end surface of each metal of the radio wave shielding structure 310 or the rotation antenna 309 to increase the insulation resistance of the metal surface. This can achieve improvement of the radio wave shielding performance and improvement of the safety due to reduction of discharge.

The divider 305 divides the heating chamber 301 in the height direction Z, and the inner wall 312 of the heating chamber 301 has the inclination surface 324 for centering the divider 305 toward the center of the heating chamber 301. According to this configuration, when the inclination surfaces are not parallel to each other, the inclination surfaces are in contact with each other at a point or a line, and therefore the inclination surfaces become slippery, on the other hand, when the inclination surfaces 324 and 325 are parallel to each other, the inclination surfaces 324 and 325 are in contact with each other in a wide area, and therefore the inclination surfaces become less slippery. Therefore, by providing the divider 305 and the rail 323 with the inclination surface 324, the divider 305 can slide to a position where the inclination surfaces 324 and 325 become parallel to each other by the own weight of the divider 305, and the position of the divider 305 with respect to the inner wall of the heating chamber 301 can be stabilized. Thus, the shielding performance of the divider 305 can be stabilized.

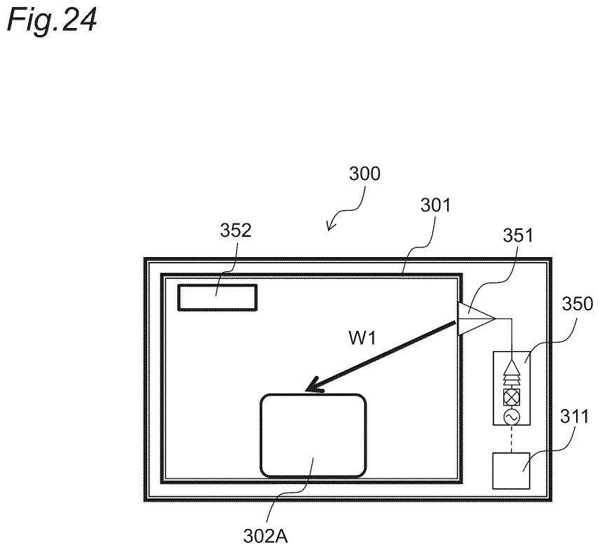

The divided chambers 328A and 328B are provided with the microwave sensors 318A and 318B. According to this configuration, various controls become possible using detection results of the microwave sensors 318A and 318B. The control will be described with reference to FIGS. 24 to 32.

### 1.3.3 Usage Example of Microwave Sensor

FIG. 24 is a schematic view regarding a usage example of a microwave sensor using a heating device 300 according to the third embodiment. As shown in FIG. 24, the heating device 300 includes a microwave generator 350 for generating a microwave W1, a microwave radiator 351 for radiating the microwave generated by the microwave generator 350 to the object 302A to be heated in the heating chamber 301, and a heating unit 352 for heating the object 302A to be heated by means different from microwaves. The microwave generator 350 is connected to a control unit 311. The heating unit 352 is a heating source (heater) other than a microwave heating source such as, for example, a radiation heating source, a hot air convection heating source, and a steam heating source.

The microwave generator 350 and the microwave radiator 351 shown in FIG. 24 have both a function of radiating microwaves and a function of detecting radiated microwaves, and also function as a microwave sensor. The microwave sensor is incorporated in, for example, the microwave radiator 351 or the microwave generator 350. Not limited to such case, as in the configuration example of the heating device 300 shown in FIG. 18A, the microwave generator 303 and the microwave radiator 304, and the microwave sensors 318A and 318B may be separate bodies, and similar control can be applied.

The control unit 311 detects the power of a reflected wave over time by the microwave sensor, determines the state of the object 302A to be heated based on the temporal change in the power of the reflected wave, and performs processing of controlling the radio wave irradiated by the microwave radiator 351 based on the determination result.

For example, if the state of the object 302A to be heated is a heating end state based on a temporal change in power of the reflected wave, the control unit 311 may end the heating processing by controlling the radio wave irradiated by the microwave radiator 351.

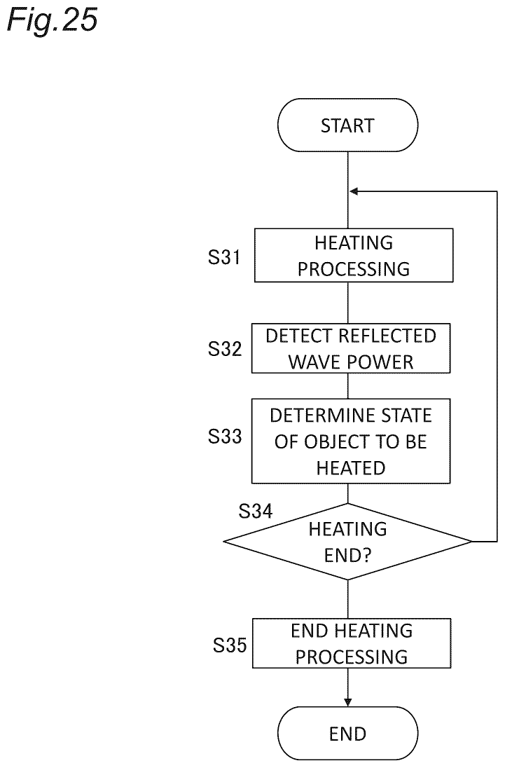

The operation of the control unit 311 in this case will be described with reference to the flowchart shown in FIG. 25. The control unit 311 starts the heating processing (S31), detects the reflected wave power by the microwave sensor (S32), and determines the state of the object 302A to be heated based on the temporal change in the reflected wave power (S33). As a result of the determination, if the state of the object 302A to be heated is the heating end state (YES in S34), the control unit 311 ends the heating processing (S35).

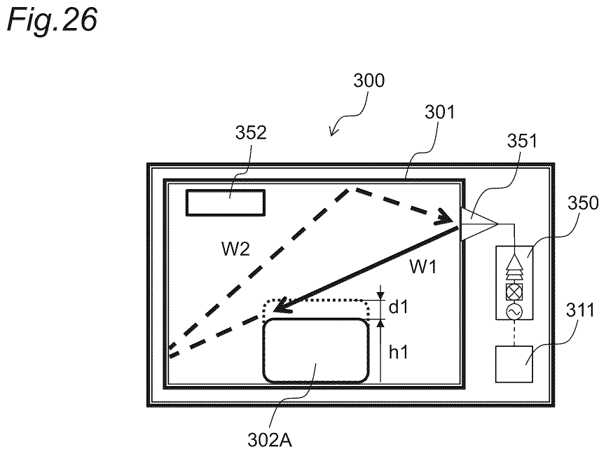

For example, a case where the object 302A to be heated is water, and the object 302A to be heated is boiled by heating processing will be described as an example. In this case, the heating end state is a state where the object 302A to be heated is boiling. FIG. 26 is an explanatory diagram of detection of a state change of the object 302A to be heated, and shows a case where the object 302A to be heated is boiling. When the object 302A to be heated is boiling, the liquid level of the object 302A to be heated moves up and down, and therefore the liquid level height changes between h1 and h1+d1. When the liquid level height is h1+d1, the object 302A to be heated is irradiated with the microwave W1, but when the liquid level height is h1, the microwave W1 hits the wall surface of the heating chamber 301 without hitting the object 302A to be heated, and is reflected and detected by the microwave sensor as a reflected wave W2. Accordingly, it is possible to determine whether or not the state of the object 302A to be heated is a state where the object 302A to be heated is boiling based on a temporal change of the reflected wave power detected by the microwave sensor.

For example, if the state of the object 302A to be heated is a condition change state based on a temporal change in power of the reflected wave, the control unit 311 may change the heating condition by controlling the radio wave irradiated by the microwave radiator 351. The change of the heating condition may be switching, for example, from heating by the microwave generator 350 to heating by the heating unit 352. The change of the heating condition is not particularly limited, and may be a change of at least one of power, frequency, and phase difference of the radio wave generated by the microwave generator 350.

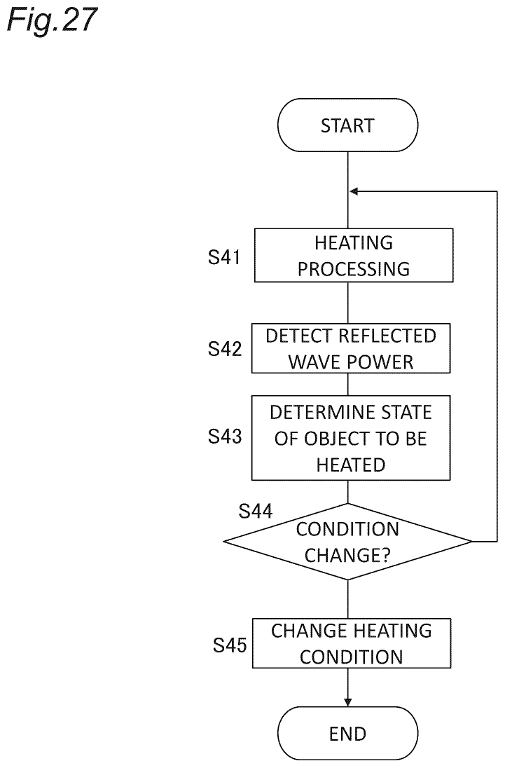

The operation of the control unit 311 in this case will be described with reference to the flowchart shown in FIG. 27. The control unit 311 starts the heating processing (S41), detects the reflected wave power by the microwave sensor (S42), and determines the state of the object 302A to be heated based on the temporal change in the reflected wave power (S43). As a result of the determination, if the state of the object 302A to be heated is the condition change state (YES in S44), the control unit 311 changes the heating condition (S45).

Examples of the condition change state of the object 302A to be heated include a shape change due to swelling, an increase in local permittivity due to melting, an increase in local permittivity due to thawing, a change in position, and a decrease in permittivity due to drying.

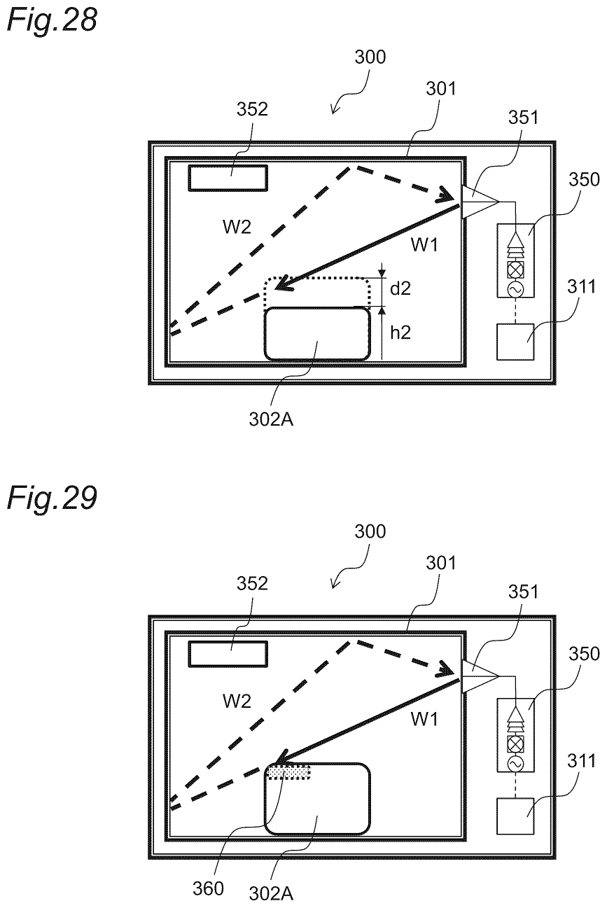

FIG. 28 is an explanatory diagram of detection of a state change of the object 302A to be heated, and shows a case where a shape change occurs due to swelling of the object 302A to be heated. When the object 302A to be heated is swollen, the height of the object 302A to be heated changes from h2 to h2+d2. When the height of the object 302A to be heated is h2, the microwave W1 hits the wall surface of the heating chamber 301 without hitting the object 302A to be heated, and is reflected and detected by the microwave sensor as a reflected wave W2. When the height of the object 302A to be heated is h2+d2, the object 302A to be heated is irradiated with the microwave W1 and the microwave W1 is absorbed. Accordingly, it is possible to determine whether or not the object 302A to be heated has undergone shape change due to swelling as the state of the object 302A to be heated based on a temporal change in the reflected wave power detected by the microwave sensor.

FIG. 29 is an explanatory diagram of detection of a state change of the object 302A to be heated, and shows a case where a local permittivity increase occurs due to melting of the object 302A to be heated. The power of the microwave absorbed by the dielectric is proportional to the relative permittivity of the dielectric. After a melting part 360 occurs in the object 302A to be heated, the power of the radio wave absorbed by the melting part 360 increases, and the power of the reflected wave W2 decreases. Accordingly, it is possible to determine whether or not the object 302A to be heated has been partially melted and a local permittivity increase has occurred as the state of the object 302A to be heated based on a temporal change in the reflected wave power detected by the microwave sensor.

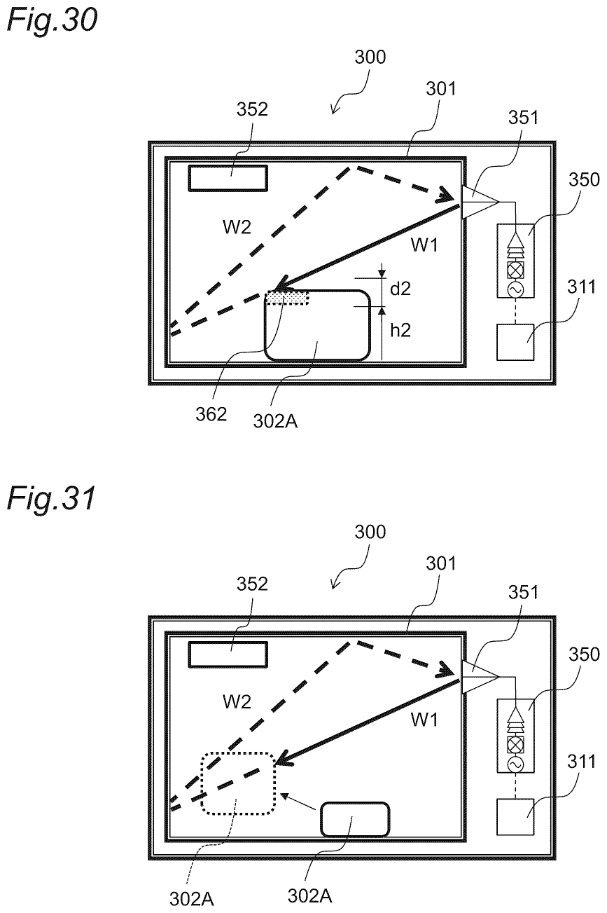

FIG. 30 is an explanatory diagram of detection of a state change of the object 302A to be heated, and shows a case where a local permittivity increase occurs due to thawing of the object 302A to be heated. This state change occurs when the object 302A to be heated is a frozen food and the object 302A to be heated is thawed by heating processing. The power of the microwave absorbed by the dielectric is proportional to the relative permittivity of the dielectric. After a thawing part 362 occurs on the object 302A to be heated, the power of the radio wave absorbed by the thawing part 362 increases, and the power of the reflected wave W2 decreases. Accordingly, it is possible to determine whether or not the object 302A to be heated has been partially thawed and a local permittivity increase has occurred as the state of the object 302A to be heated based on a temporal change in the reflected wave power detected by the microwave sensor.

FIG. 31 is an explanatory diagram of detection of a state change of the object 302A to be heated, and shows a case where the position of the object 302A to be heated is changing. For example, in heating processing, there is a case where a part of the object 302A to be heated bursts, the object 302A to be heated moves in the heating chamber 301, and the position of the object 302A to be heated changes. For example, when the object 302A to be heated is in the initial position, the microwave W1 hits the wall surface of the heating chamber 301 without hitting the object 302A to be heated, and is reflected and detected by the microwave sensor as a reflected wave W2. On the other hand, for example, when the object 302A to be heated moves from the initial position, the object 302A to be heated is irradiated with the microwave W1 and the microwave W1 is absorbed. Accordingly, it is possible to determine whether or not the object 302A to be heated has moved and the position has changed as the state of the object 302A to be heated based on a temporal change in the reflected wave power detected by the microwave sensor.

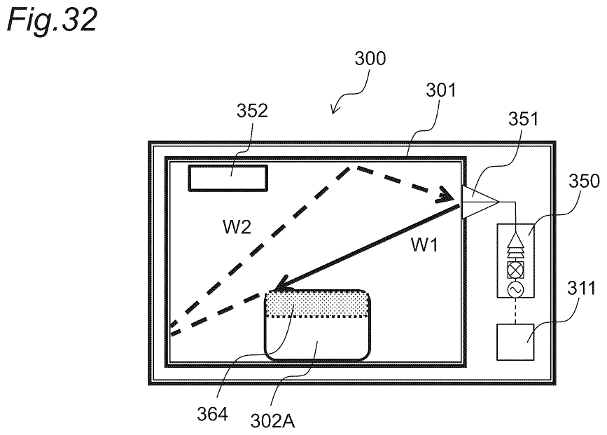

FIG. 32 is an explanatory diagram of detection of a state change of the object 302A to be heated, and shows a case where a decrease in permittivity occurs due to drying of the object 302A to be heated. The power of the microwave absorbed by the dielectric is proportional to the relative permittivity of the dielectric. After a dry part 364 occurs on the object 302A to be heated, the power of the radio wave absorbed by the dry part 364 decreases, and the power of the reflected wave W2 increases. Accordingly, it is possible to determine whether or not the object 302A to be heated has been partially dried and a decrease in permittivity has occurred as the state of the object 302A to be heated based on a temporal change in the reflected wave power detected by the microwave sensor.

Also in the present embodiment, reflectance may be employed in place of reflected wave power.

As described above, in the present embodiment, the control unit 311 has a function as a state detection means that detects a state change of the object 302A to be heated from a change in reflected wave power or reflectance, and a function as a control means that controls microwaves in accordance with the detected state. The control unit 311 detects a state change (e.g., boiling, swelling, melting, thawing, bursting, and drying) of the object 302A to be heated from the change in reflected wave power or reflectance, and changes the heating condition or ends the heating. Here, control of microwaves includes irradiation of microwaves, stopping of irradiation of microwaves, change of the frequency of microwaves, and output adjustment of microwaves.

The progress of heating of the object 302A to be heated may cause shaking and shape change of the object 302A to be heated such as boiling and swelling, and rapid permittivity change of the object 302A to be heated such as melting and drying. This change in the state of this object 302A to be heated changes the microwave absorption characteristics of the object 302A to be heated, and therefore a change occurs also in reflected wave power or reflectance. Changing the heating condition or ending the heating at the time point when the state of the object 302A to be heated changes is effective in mitigating excess or deficiency of heating and bringing high-quality finishing. Conventionally, cooking is performed with change time of the heating condition and end time of heating determined in advance, or temperature in the heating chamber is measured by a thermocouple to change the heating condition and end the heating, and therefore, in a case where the weight, the container, and the initial temperature of the object 302A to be heated are different from assumption, excess or deficiency of heating easily occurs, and automatic cooking with high-quality finishing cannot be achieved. However, in the present embodiment, by detecting the state of the object 302A to be heated, automat cooking with high-quality finishing becomes possible. If information on the object 302A to be heated such as information on the weight of the object 302A to be heated, the current temperature of the object 302A to be heated, and the type of the object 302A to be heated are available, the accuracy of state change detection of the object 302A to be heated can be further improved. For example, auxiliary information such as reflectance is calculated from the relationship between the detected reflected wave power and the power of the incident wave (irradiation wave) and used as feedback information, whereby the accuracy can be further improved.

In the determination of the state using the reflected wave power, in particular, only the reflected wave power with respect to the frequency may be used, or a representative value (e.g., mean value, maximum value, minimum value, mode value, median value, center value, or the like) of the reflected wave power with respect to a plurality of frequencies may be used. In the determination of the state using the reflected wave power, determination of the state may be performed based on whether or not a change degree, a standard deviation, or the like per arbitrary time of reflected wave power or reflectance has exceeded a preset threshold.

### 1.3.4 Modification of Third Embodiment

FIG. 18B is a schematic side view of a configuration example of the microwave heating device 300 according to the modification of the third embodiment.

The microwave heating device 300 shown in FIG. 18B includes a magnetron 370, a waveguide 372, and a microwave sensor 374.

The magnetron 370 is an example of a microwave generator, and supplies the waveguide 372 with microwaves. The waveguide 372 is a member that propagates the microwaves generated by the magnetron 370, and is coupled to the microwave radiator 304 and the rotation antenna 309. The microwave sensor 374 is a sensor that detects microwaves propagating through the waveguide 372.

According to the above configuration, the microwave generated by the magnetron 370 is supplied to the microwave radiator 304 and the rotation antenna 309 through the waveguide 372, whereby the microwave can be radiated from the rotation antenna 309 toward the divided chambers 328A and 328B. Use of the microwave sensor 374 can also execute control similar to the “usage example of microwave sensor” described with reference to FIGS. 24 to 32.

The configuration including the magnetron 370 and the waveguide 372 as shown in FIG. 18B may be applied to all the embodiments.

### 1.4 Fourth Embodiment

### 1.4.1 Configuration

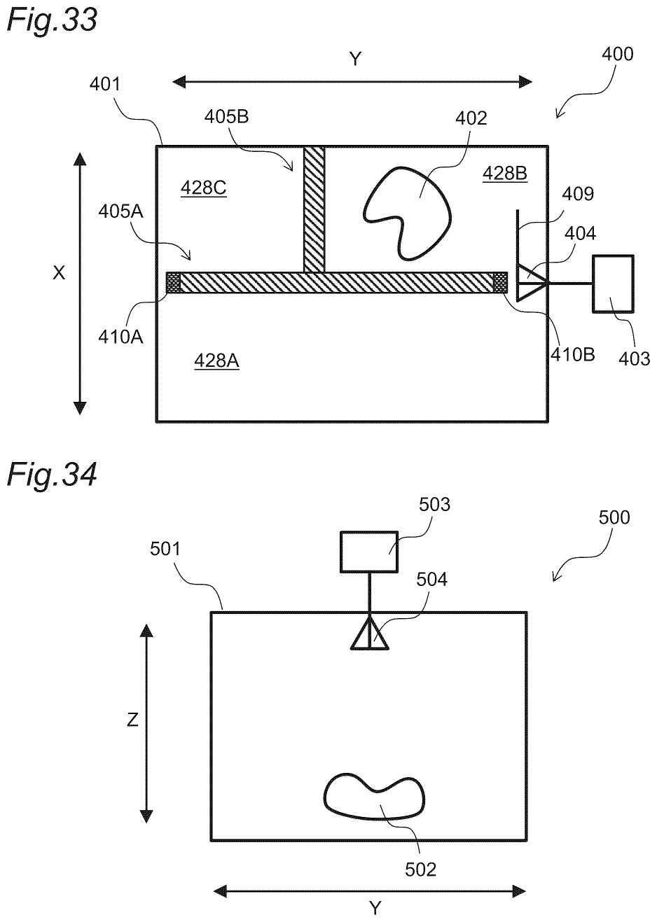

FIG. 33 is a schematic top view of a configuration example of a microwave heating device 400 according to the fourth embodiment. The microwave heating device 400 shown in FIG. 33 includes a heating chamber 401, a microwave generator 403, a microwave radiator 404, and dividers 405A and 405B.

The heating chamber 401 shown in FIG. 33 is divided into three divided chambers 428A, 428B, and 428C by the two dividers 405A and 405B. The divider 405A extends in the depth direction Y so as to divide the heating chamber 301 in the width direction X. The divider 405B extends in the width direction X so as to further divide, in the depth direction Y, a space on one side of the heating chamber 301 divided by divider 405A. In the example shown in FIG. 33, an object 402 to be heated is disposed in the divided chamber 428B.

The divider 405A is made of a material that shields microwaves such as metal, for example. On the other hand, the divider 405B is made of a material that transmits microwaves such as resin, for example, that is, a dielectric. Due to this, microwaves are shielded by the divider 405A between the divided chamber 428A and the divided chambers 428B and 428C, and microwaves are transmitted without being shielded by the divider 405B between the divided chamber 428B and the divided chamber 428C.

The divider 405A further includes radio wave shielding structures 410A and 410B at end parts facing the heating chamber 401. In the present embodiment, the radio wave shielding structures 410A and 410B adopt different types of structures. For example, depending on the distance between the divider 405A and an inner wall of the heating chamber 401, the radio wave shielding structure 410A on a side not close to the radio wave radiator 404 is a non-contact radio wave shielding structure, and the radio wave shielding structure 410B on a side close to the radio wave radiator 404 is a contact radio wave shielding structure.

The microwave radiator 404 is provided on a side surface side of the heating chamber 401, and includes a rotation antenna 409. The rotation antenna 409 radiates microwaves toward, for example, each of the divided chamber 428B and the divided chamber 428A. The microwaves radiated toward the divided chamber 428B can transmit through the divider 405B and enter the divided chamber 428C.

As shown in FIG. 33, when the object 402 to be heated is disposed in the divided chamber 428B and no object to be heated is disposed in other divided chambers 428A and 428C, the microwave radiator 404 is controlled so as to radiate microwaves toward the divided chamber 428B in a state of stopping the rotation antenna 409, for example. Due to this, the rotation antenna 409 constantly radiates microwaves toward the divided chamber 428B. On the other hand, when another object to be heated is disposed in the divided chamber 428A in addition to the object 402 to be heated disposed in the divided chamber 428B, the microwave radiator 404 is controlled so as to radiate microwaves while continuously rotating the rotation antenna 409, for example. In this case, the microwave radiator 404 radiates microwaves toward the divided chamber 428A in the first rotation range, and radiates microwaves toward the divided chamber 428B in the second rotation range. This can alternately heat the object 402 to be heated disposed in the divided chamber 428B and an object to be heated disposed in the divided chamber 428A, enabling heating of multiple items.

### 1.4.2 Actions and Effects

The microwave heating device 400 of the fourth embodiment described above has a function of heating the object 402 to be heated only in one divided chamber (e.g., divided chamber 428B) of the divided chambers 428A to 428C. According to this configuration, by putting the object 402 to be heated into one divided chamber, it becomes possible to change the heating condition for each object 402 to be heated. By heating the object 402 to be heated that is put in the plurality of divided chambers 428A to 428C equivalent in size to the object 402 to be heated, highly efficient heating becomes possible. This can achieve short-time and high-temperature heating and energy-saving heating. When a plurality of the objects 402 to be heated are put in one divided chamber, similar effects can be achieved. It is effective if the divided chamber in which the object 402 to be heated is put is smaller in size than the heating chamber 401 before division, and therefore, it is effective even if the divided chamber is not equivalent in size to the object 402 to be heated.

The divider 405B is made of a dielectric. According to this configuration, microwaves transmit through the dielectric, but hot air and steam do not transmit through the dielectric. Therefore, the degree of heating by heating sources other than microwaves can be changed for each divided chamber. By dividing the heating chamber 401, it becomes possible to heat food by hot air heating and steam heating in a small space, and highly efficient heating becomes possible. This makes it possible to select a heating source suitable for each object to be heated, and to achieve simultaneous heating of multiple items, short-time and high-temperature heating, and energy-saving heating. Typical examples of dielectric include ceramic, resin, and glass.

The divider 405A divides the heating chamber 401 in the depth direction X. According to this configuration, dividing the heating chamber 401 in the depth direction Y enables heating of multiple items, and formation of the divided chamber without limiting dimensions of the object 402 to be heated in the height direction Z or the width direction Y as compared with that before the division. This can achieve simultaneous heating of multiple items, and mitigate dimensional restriction of the object 402 to be heated that can be heated. The present configuration is particularly effective when the object to be heated disposed in the divided chamber 428A has a large dimension in the width direction Y such as pasta.

The microwave radiator 404 radiates microwaves from a side surface of the heating chamber 401 to the heating chamber 401. According to this configuration, many microwave ovens have a configuration in which a door is provided in front, and the object 402 to be heated is taken out from front. Perforated metal is used for a flat part of the metal of the door so that the inside of the heating chamber 401 can be seen from the outside of the door, and a dielectric such as a transparent glass plate or a resin plate is disposed on the heating chamber 401 side of the perforated metal in order to increase a degree of sealing in the heating chamber 401 and improve cleanability. Therefore, the shape of the wall surface and the permittivity of the constituent elements are greatly different in the front-rear direction of the heating chamber 401, and thus the heating distribution of the object 402 to be heated is often greatly different in the front-rear direction. Therefore, by providing the side surface of the heating chamber 401 with the microwave radiator 404 (power feed unit), and controlling, in the front-rear direction, the directivity of the microwaves radiated from the microwave radiator 404 to the heating chamber 401, it is possible to uniform the heating distribution in the front-rear direction of the object 402 to be heated. By providing the side surface of the heating chamber 401 with the microwave radiator 404, and controlling, in the up-down direction, the directivity of the microwaves radiated from the microwave radiator 404 to the heating chamber 401, it is possible to uniform the heating distribution in the up-down direction of the object 402 to be heated. This can achieve uniform heating.

The microwave radiator 404 has a function of radiating microwaves while stopping the rotation antenna 409. According to this configuration, by stopping the rotation antenna 409 and concentratedly radiating microwaves to one divided chamber (e.g., divided chamber 428B), it becomes possible to perform concentrated microwave heating on the object 402 to be heated in the divided chamber 428B. This can achieve concentrated heating. In practice, when the rotation antenna 409 is fixed in one direction and microwave heating is performed for a long time, the standing wave distribution in the heating chamber 401 is fixed and discharge and uneven heating easily occur, and therefore, the stopping operation and the rotating operation of the rotation antenna 409 may be combined. When the shape of the rotation antenna 409 is branched and microwaves can be radiated in two directions, it also becomes possible to perform simultaneous and concentrated microwave heating on objects to be heated in two divided chambers.

The microwave radiator 404 has a function of radiating microwaves while continuously rotating the rotation antenna 409. According to this configuration, by continuously rotating the rotation antenna 409 to heat an object to be heated, it becomes possible to heat the object to be heated while changing the standing wave distribution in the divided chambers 428A to 428C determined by the rotation angle of the rotation antenna 409, and it becomes possible to improve uniformity of heating. When in the plurality of divided chambers 428A to 428C, the divided chambers 428A to 428C that radiate microwaves more strongly are changed depending on the rotation angle of the rotation antenna 409, it becomes possible to simultaneously heat the objects to be heated in the plurality of divided chambers 428A to 428C. This can achieve uniform heating and simultaneous heating of multiple items.

The radio wave shielding structures 410A and 410B have the contact radio wave shielding structure 410B (first radio wave shielding structure) and the non-contact radio wave shielding structure 410A (second radio wave shielding structure). According to this configuration, it is possible to select the type of the radio wave shielding structures 410A and 410B from non-contact and contact depending on a positional relationship between the inner wall of the heating chamber 401 and the divider 405A. In a part where the plate-shaped divider 405A is held by providing the inner wall of the heating chamber 401 with unevenness, the divider 405A and the heating chamber 401 are in contact with each other, and therefore, use of a contact shielding structure enables the shielding configuration of the divider 405A to be simplified. For a part where the divider 405A and the heating chamber 401 are not in contact with each other, use of a non-contact shielding configuration can stably secure shielding performance. Thus, the structure of the dividers 405A and 405B can be simplified.

### 1.5 Fifth Embodiment

### 1.5.1 Configuration

FIG. 34 is a schematic front view of a configuration example of a microwave heating device 500 according to the fifth embodiment. The microwave heating device 500 shown in FIG. 34 includes a heating chamber 501, a microwave generator 503, and a microwave radiator 504.

The microwave heating device 500 includes a divider (not illustrated) for dividing the heating chamber 501, the divider is detachable, and FIG. 34 shows a state where the divider is removed.

The microwave radiator 504 is provided on a top surface side of the heating chamber 501, and the object 502 to be heated is disposed in the heating chamber 501. In the configuration, in a state where the divider is removed, the microwave radiator 504 radiates microwaves from the top surface of the heating chamber 501 toward the heating chamber 501 to perform microwave heating on the object 502 to be heated.

### 1.5.2 Actions and Effects

The microwave heating device 500 of the fifth embodiment described above radiates microwaves from the microwave radiator 504 into the heating chamber 501 in a state where the divider is removed from the heating chamber 501. According to this configuration, the object 502 to be heated having a dimension that allows the object to be put in the heating chamber 501 becomes heatable. This can mitigate dimensional restriction of the object 502 to be heated that can be heated.

The microwave radiator 504 radiates microwaves from the top surface of the heating chamber 501 to the heating chamber 501. According to this configuration, by radiating microwaves from the top surface of the heating chamber 501, it is possible to secure the distance between the object 502 to be heated and the microwave radiator 504 (power feed unit) longer than that in a configuration in which power is fed from a bottom surface of the heating chamber 501. This makes it possible to hit microwaves to the object 502 to be heated while diffusing the microwaves in the heating chamber 501 from the microwave radiator 504. The present configuration is particularly effective for the object 502 to be heated that is low in height and the object 502 to be heated in which uniformity of heating distribution in the horizontal direction is important. This can achieve uniform heating.

### 1.6 Sixth Embodiment

### 1.6.1 Configuration

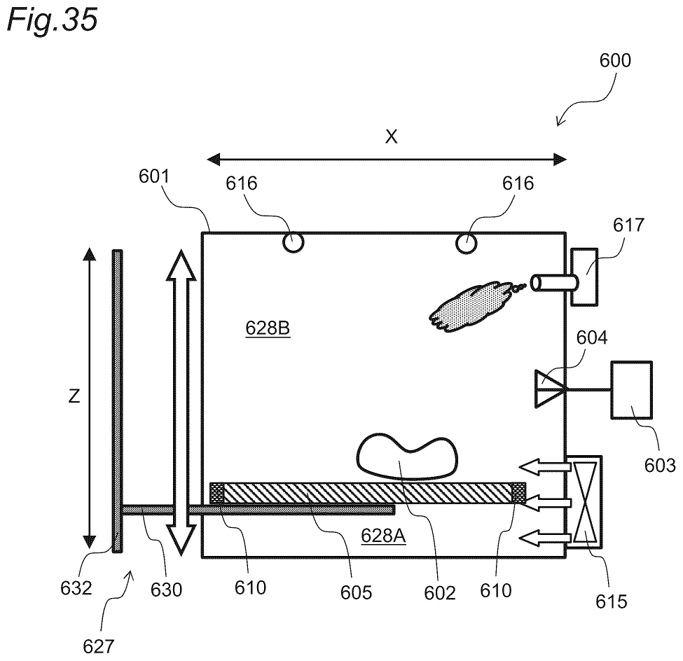

FIG. 35 is a schematic side view of a configuration example of a microwave heating device 600 according to the sixth embodiment. The microwave heating device 600 shown in FIG. 35 includes a heating chamber 601, a microwave generator 603, a microwave radiator 604, a divider 605, a hot air heating means 615, a radiation heating means 616, a steam heating means 617, and a divider movement mechanism 627.

The heating chamber 601 shown in FIG. 35 is divided in the height direction Z by the divider 605 to form two divided chambers 628A and 628B. The divider 605 is made of a material such as metal that shields microwaves, for example, and includes a radio wave shielding structure 610. In FIG. 35, an object 602 to be heated is disposed on an upper surface of the divider 605.

The divider movement mechanism 627 is a mechanism for moving the divider 605 in the up-down direction. The divider movement mechanism 627 moves the divider 605 before heating or during heating, for example. The divider movement mechanism 627 includes a placement portion 630 and a slide portion 632. The placement portion 630 is a member for placing the divider 605, and has a plate shape extending in the horizontal direction, for example. The slide portion 632 is a member that movably supports the placement portion 630 in the up-down direction, and extends along the height direction Z. Although not illustrated, a gap (slit) through which the placement portion 630 passes is formed on a side wall of the heating chamber 601.

The microwave radiator 604 is provided on a side surface side of the heating chamber 601. The hot air heating means 615 is a member for heating with hot air, and is provided on the side surface side of the heating chamber 601 similarly to the microwave radiator 604. The radiation heating means 616 is a member for heating with radiation, and is provided on a top surface side of the heating chamber 601. The steam heating means 617 is a member for heating with steam, and is provided on the side surface side of the heating chamber 601 similarly to the microwave radiator 604 and the steam heating means 617.

### 1.6.2 Actions and Effects

According to the microwave heating device 600 of the sixth embodiment described above, the divider 605 is configured to be movable before heating or during heating. According to this configuration, by moving the divider 605 before heating, it becomes possible to set a dimension of the divided chamber 628B equivalent to a size of the object 602 to be heated. By moving the divider 605 during heating, it is possible to change the dimension of the divided chamber 628B, and it becomes possible to change the heating condition such as distribution of each of microwaves, hot air, and steam. This enables flexible change of heating conditions in conformity to a heating state of the object 602 to be heated. In a case where the divider 605 is metal, the standing wave distribution of microwaves greatly changes due to a change in the dimension of the divided chamber 628B. This enables uniformization of the heating distribution by microwave heating.

### 1.7 Seventh Embodiment

### 1.7.1 Configuration

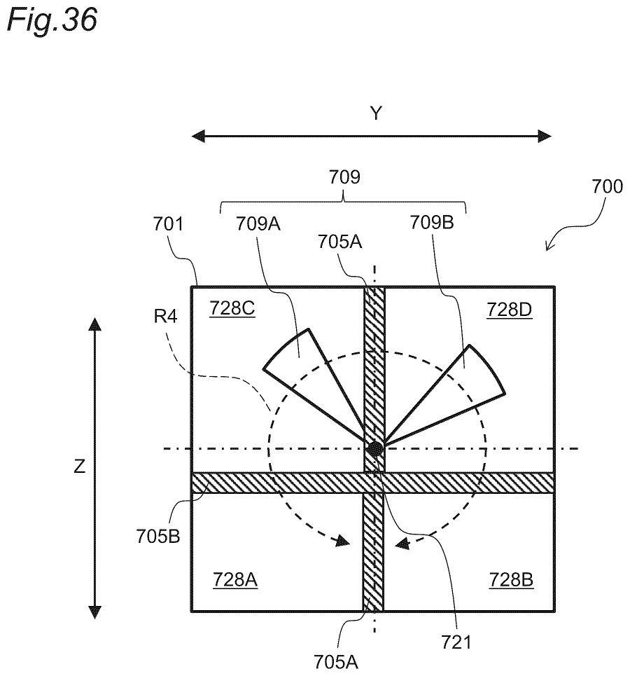

FIG. 36 is a schematic front view of a configuration example of a microwave heating device 700 according to the seventh embodiment. The microwave heating device 700 shown in FIG. 36 includes a heating chamber 701, dividers 705A and 705B, and a microwave radiator 709.

The heating chamber 701 shown in FIG. 36 is divided in the width direction Y and the height direction Z by the dividers 705A and 705B to form four divided chambers 728A, 728B, 728C, and 728D. The divider 705A extends in the height direction Z so as to divide the heating chamber 701 in the width direction Y. The divider 705B extends in the width direction Y so as to divide the heating chamber 701 in the height direction Z. The divider 705A is disposed at an intermediate position in the width direction Y so as to overlap a rotation center 721 of rotation antennas 709A and 709B described later, for example. The divider 705B is disposed at a lower height position with respect to the rotation center 721 of the rotation antennas 709A and 709B, for example. The dividers 705A and 705B may be, for example, separate bodies or an integrated body. The dividers 705A and 705B may be fixed to an inner wall of the heating chamber 701, for example, or may be detachable.

The microwave radiator 709 is provided on a back surface side of the heating chamber 701, and includes the rotation antennas 709A and 709B. The rotation antennas 709A and 709B are configured to radiate microwaves toward the heating chamber 701, and for example, the rotation antenna 709A radiates microwaves in a first direction, and the rotation antenna 709B radiates microwaves in a second direction. Microwave radiation by the microwave radiator 709 is divided into plurality by the rotation antennas 709A and 709B. More specifically, a plurality of radiation points at which the distance from a feeding coupling point of the antenna becomes an integral multiple of 2/2 are provided, and the radiation directivity from the antenna is made plurality.

The rotation antennas 709A and 709B are integrally rotatable along a rotation direction R4 with the center position 721, which is a center in the width direction X and the height direction Z of the heating chamber 701, as a rotation center. An angle formed by the rotation antenna 709A and the rotation antenna 709B when the heating chamber 701 is viewed from the front is set to approximately 90 degrees. While the rotation antenna 709A radiates microwaves toward one divided chamber, the rotation antenna 709B radiates microwaves toward a divided chamber adjacent to the divided chamber. Due to this, microwaves are simultaneously radiated to the plurality of divided chambers.

### 1.7.2 Actions and Effects

According to the microwave heating device 700 of the seventh embodiment described above, the microwave radiator 709 has a function of simultaneously radiating microwaves in the first direction and the second direction. According to this configuration, antenna feeding power can be divided into a plurality of directions and radiated. This can increase the number of heating patterns, and make optimum heating for a wide variety of foods selectable.

The microwave radiator 709 has a function of simultaneously radiating microwaves to the plurality of divided chambers 728A to 728D using microwaves radiated in the first direction and the second direction. According to this configuration, for example, when feeding power using the rotation antenna 709, by performing rotation control of the rotation antenna 709, it becomes possible to perform power feed control to the plurality of divided chambers 728A to 728D. Due to this, it is possible to achieve simultaneous finishing of multiple items, it becomes possible to heat one object to be heated while keeping the temperature of another object to be heated, and it becomes possible to simultaneously heat multiple items with similar conditions.

### 1.8 Eighth Embodiment

### 1.8.1 Configuration

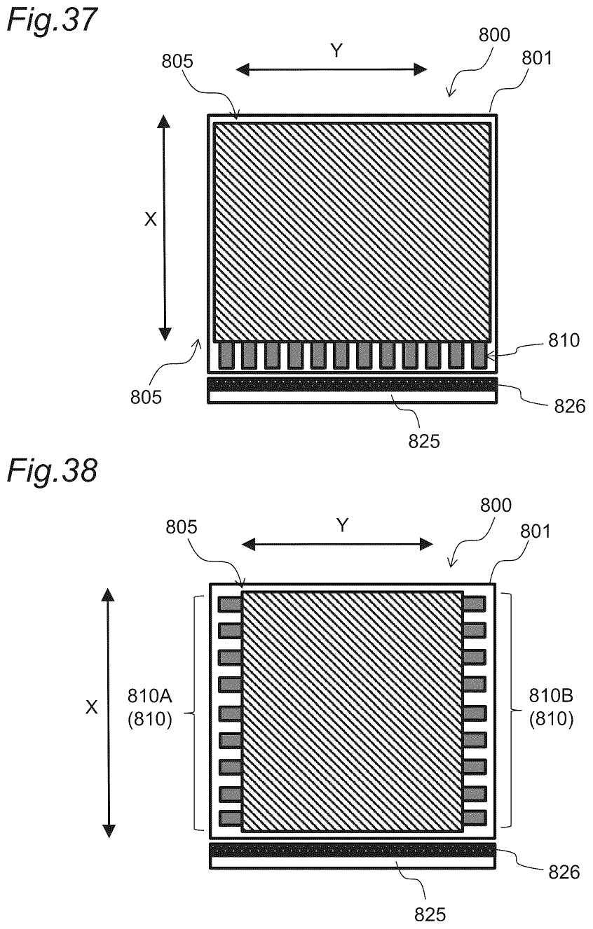

FIG. 37 is a schematic top view of a configuration example of a microwave heating device 800 according to the eighth embodiment. The microwave heating device 800 shown in FIG. 37 includes a heating chamber 801, a divider 805, and a door 825.

The divider 805 shown in FIG. 37 includes a radio wave shielding structure 810 only on one of the four sides. Among the four sides of the divider 805, one side facing door glass 826 of the door 825 is provided with the radio wave shielding structure 810.

### 1.8.2 Actions and Effects

According to the microwave heating device 800 of the eighth embodiment described above, one side of the divider 805 is provided with a radio wave shielding structure 810. According to this configuration, by providing one side of the divider 805 with the radio wave shielding structure 810, the radio wave shielding performance of the divider 805 is improved. The standing wave distribution in the heating chamber 801 is different in each side of the divider 805, and therefore a leakage radio wave amount is also different in each side. Therefore, by providing the radio wave shielding structure 810 on one side where the leakage radio wave amount is large, it becomes possible to further improve the shielding performance.

### 1.8.3 Modification of Eighth Embodiment

### 1.8.3.1 First Modification

### 1.8.3.1.1 Configuration

FIG. 38 is a schematic top view of a configuration example of the microwave heating device 800 according to a first modification of the eighth embodiment.

The divider 805 shown in FIG. 38 includes the radio wave shielding structure 810 only on two side of the four sides. Among the four sides of the divider 805, two sides facing both end parts (side walls) in the width direction X of the heating chamber 801 are provided with radio wave shielding structures 810A and 810B.

### 1.8.3.1.2 Actions and Effects

According to the microwave heating device 800 of the eighth embodiment described above, two sides of the divider 805 are provided with radio wave shielding structures 810A and 810B. According to this configuration, by providing the two sides of the divider 805 with the radio wave shielding structures 810A and 810B, the radio wave shielding performance of the divider 805 is improved. The standing wave distribution in the heating chamber 801 is different in each side of the divider 805, and therefore a leakage radio wave amount is also different in each side. Therefore, by providing the radio wave shielding structures 810A and 810B on the two sides where the leakage radio wave amount is large, it becomes possible to further improve the shielding performance.

### 1.8.3.2 Second Modification

### 1.8.3.2.1 Configuration

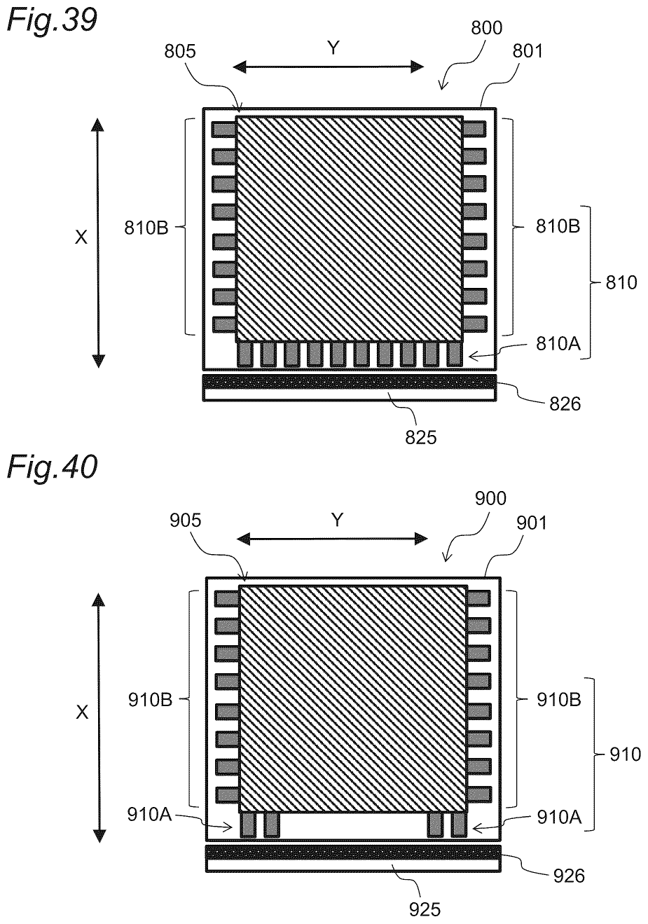

FIG. 39 is a schematic top view of a configuration example of the microwave heating device 800 according to a second modification of the eighth embodiment.

The divider 805 shown in FIG. 39 includes the radio wave shielding structure 810 only on three sides of the four sides. Among the four sides of the divider 805, one side facing the door glass 826 of the door 825 is provided with the radio wave shielding structure 810A, and two sides facing both end parts (side walls) in the width direction X of the heating chamber 801 are provided with the radio wave shielding structure 810B.

### 1.8.3.2.2 Actions and Effects

According to the microwave heating device 800 of the eighth embodiment described above, three sides of the divider 805 are provided with the radio wave shielding structures 810A and 810B. According to this configuration, by providing the three sides of the divider 805 with the radio wave shielding structures 810A and 810B, the radio wave shielding performance of the divider 805 is improved. The standing wave distribution in the heating chamber 801 is different in each side of the divider 805, and therefore a leakage radio wave amount is also different in each side. Therefore, by providing the radio wave shielding structures 810A and 810B on the three sides where the leakage radio wave amount is large, it becomes possible to further improve the shielding performance.

### 1.9 Ninth Embodiment

### 1.9.1 Configuration

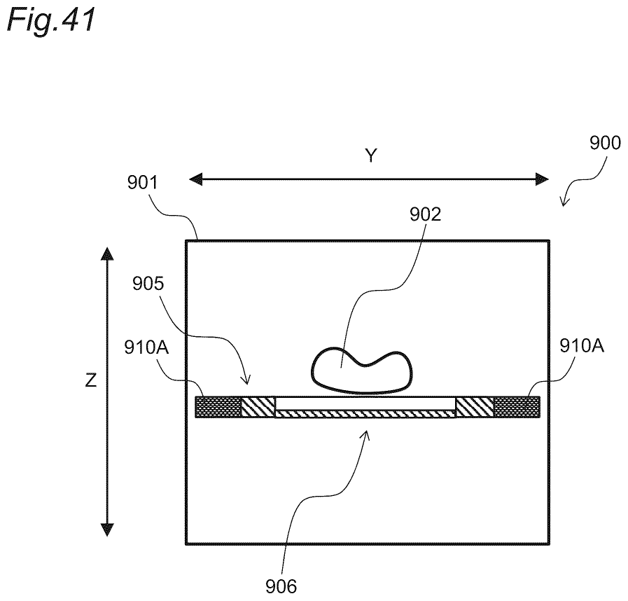

FIGS. 40 and 41 are a schematic top view and a schematic front view, respectively, of a configuration example of a microwave heating device 900 according to the ninth embodiment. The microwave heating device 900 shown in FIG. 40 includes a heating chamber 901, a divider 905, and a door 925.

The divider 905 shown in FIG. 40 includes a radio wave shielding structure 910 only on three sides of the four sides. Specifically, among the four sides of the divider 905, one side facing door glass 926 of the door 925 is provided with a radio wave shielding structure 910A, and two sides facing both end parts (side walls) in the width direction X of the heating chamber 901 are provided with a radio wave shielding structure 910B. Each of the radio wave shielding structures 910A and 910B is, for example, a non-contact choke structure. While the radio wave shielding structure 910B is provided over the entire length of the side of the divider 905, the radio wave shielding structure 910A is provided only at the end part of the side of the divider 905 and is not provided at the center part of the side. That is, the non-contact radio wave shielding structure 910A is provided in a limited range on the side facing the door 925 in the divider 905. As shown in FIG. 41, when the heating chamber 901 is viewed from the front, a center part 906 of the divider 905 is configured to open, and an object 902 to be heated placed on the divider 905 can be easily taken out.

### 1.9.2 Actions and Effects

According to the microwave heating device 900 of the ninth embodiment described above, the radio wave shielding structure 910A is non-contact, and is provided in a limited range of a side on the door 925 side in the divider 905. According to this configuration, the thickness of the divider in a case of adopting the non-contact radio wave shielding structure becomes thicker than that of a divider having a flat plate shape not provided with the radio wave shielding structure or a divider in a case of adopting the contact radio wave shielding structure. Therefore, by eliminating the radio wave shielding structure on a part of the door 925 side, which is the side on which food is taken out, the thickness of the divider 905 is partially thinned, the opening is widened, and therefore the food can be easily taken out.

### 1.10 Tenth Embodiment

### 1.10.1 Configuration

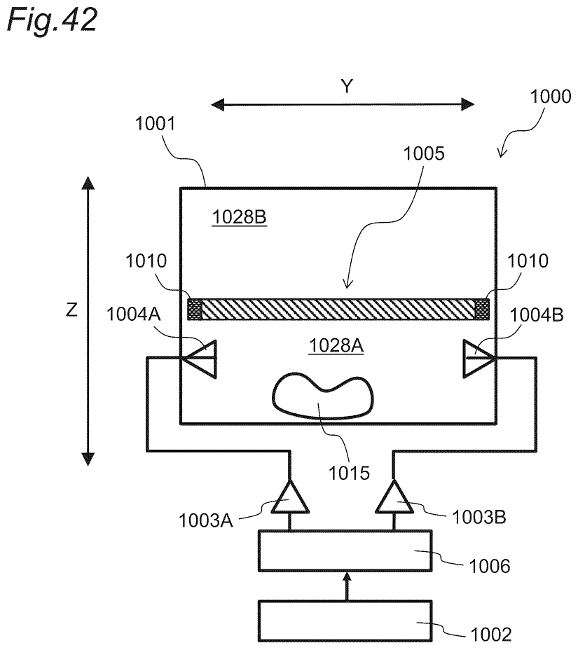

FIG. 42 is a schematic front view of a configuration example of a microwave heating device 1000 according to the tenth embodiment. As shown in FIG. 42, the microwave heating device 1000 includes a microwave signal generator 1002, two signal amplification units 1003A and 1003B, two microwave radiators 1004A and 1004B, and a phase difference control unit 1006.

The microwave signal generator 1002 is a microwave generator using a semiconductor transmitter, for example. The signal amplification units 1003A and 1003B are signal amplifiers that amplify microwave signals from the microwave signal generator 1002, and are connected to the microwave radiators 1004A and 1004B, respectively. The phase difference control unit 1006 controls a phase difference of microwaves irradiated by the plurality of microwave radiators 1004A and 1004B. The phase difference control unit 1006 is connected between the microwave signal generator 1002 and the two signal amplification units 1003A and 1003B. The phase difference control unit 1006 distributes the microwave signal from the microwave signal generator 1002 to each of the two signal amplification units 1003A and 1003B. By controlling the phase difference between radio wave signals to be distributed to the two signal amplification units 1003, the phase difference control unit 1006 controls the phase difference among a plurality of radio waves irradiated by the plurality of microwave radiators 1004. By changing the phase difference of the radio wave irradiated by the microwave radiator 1004, it is possible to use the phase difference control unit 1006 for changing the microwave distribution in the heating chamber 1001. It can be deemed that the phase difference control unit 1006 is a phase variable unit.

The phase difference control unit 1006 is configured using a variable capacitance element whose capacitance varies in accordance with an applied voltage, for example. The phase variable range by the phase difference control unit 1006 may be, for example, a range of 0° to approximately 180°. This can control, in the range of 0° to +180°, the phase difference of the power irradiated from the plurality of microwave radiators 1004.

The microwave heating device 1000 has the two radio wave irradiators 1004 disposed facing each other such that the two radio wave irradiators 1004 emit radio waves toward each other. As shown in FIG. 42, the two microwave radiators 1004 are disposed on a right side wall and a left side wall of the heating chamber 1001, and emit radio waves toward each other.

The heating chamber 1001 is provided with the divider 1005. The heating chamber 1001 is divided in the height direction Z by the divider 1005 to form two divided chambers 1028A and 1028B. In the example shown in FIG. 42, the two microwave radiators 1004 are installed in the lower divided chamber 1028A, and an object 1015 to be heated is disposed in a center part of the divided chamber 1028A.

As shown in FIG. 42, by controlling the phase difference of the microwave radiated to the divided chamber 1028A from the microwave radiator 1004 present at the position facing in the divided chamber 1028A, the radio waves are reflected by an inner wall of the divided chamber 1028A, and it becomes possible to control superposition of electric fields of direct waves before the radiation direction and the phase of the radio wave are disturbed. For example, when the phase difference of the microwaves from the microwave radiator 1004 is 180°, it becomes possible to strongly heat the center of the divided chamber 1028A. When the phase difference of the radio waves from the microwave radiator 1004 is 0°, it becomes possible to heat the periphery rather than the center of the divided chamber 1028A. When the phase difference of the radio waves from the microwave radiator 1004 is 90°, the microwave distribution can have a radio wave distribution biased to one of the microwave radiators 1004 inside the divided chamber 1028A. Thus, by controlling the phase difference in the microwaves from the plurality of microwave radiators 1004 and controlling the radio wave distribution in the divided chamber 1028A, uniform heating and selective heating of the object 1015 to be heated become possible.

In order to superimpose radio waves from the two microwave radiators 1004 in the heating device 1000 of FIG. 42, the distance between the two microwave radiators 1004 is preferably one wavelength or more at the frequency of the microwaves from the two microwave radiators 1004. That is, the distance between irradiation positions of the microwaves that becomes a target of superimposition is set to one wavelength or more at the frequency of the microwaves.

### 1.10.2 Actions and Effects

According to the microwave heating device 1000 of the tenth embodiment described above, the microwave signal generation means 1002 (microwave generator) includes a semiconductor transmitter. According to this configuration, a magnetron that is a conventional vacuum tube microwave generator requires an applied voltage of several kV, and therefore it is necessary to boost the voltage by an inverter. A semiconductor oscillator can generate microwaves with an applied voltage of several tens V. Therefore, a high-voltage component becomes unnecessary. This can achieve improvement of safety, simplification of a power feed configuration, and cost reduction (reduction in the number of components and elimination of high-withstand-voltage components).

The microwave radiators 1004A and 1004B include the microwave radiator 1004A (first microwave radiator) and the microwave radiator 1004B (second microwave radiator) different from the microwave radiator 1004A. According to this configuration, there is conventionally one power feed unit, and the directivity of microwaves is changed using a rotation antenna or the like to control the heating distribution of an object to be heated. However, in a case of a heating chamber having a size of a microwave oven, a heating distribution of an object to be heated is greatly affected by a standing wave distribution due to microwaves reflected by a heating chamber inner wall. In the case of a rotation antenna, this standing wave distribution can only be controlled in the direction of the antenna. By disposing a semiconductor oscillator in each of the plurality of power feed units, control of the frequency and the phase difference becomes possible, and the standing wave distribution becomes more variously controllable. This can achieve uniform heating and selective heating. In a case of a configuration in which microwave output of each power feed unit can be independently controlled, by radiating microwaves from a semiconductor microwave oscillator close to the object 1015 to be heated desired to heat, it is possible to selectively heat the object 1015 to be heated.

The phase control unit 1006 (phase difference control means) that controls the phase of the microwaves radiated by each of the microwave radiator 1004A and the microwave radiator 1004B is further included. According to this configuration, by changing the phase difference between the plurality of microwave radiators 1004A and 1004B, the superimposing direction of the electric fields at each place in the heating chamber 1001 changes, and therefore the radio wave distribution in the entire heating chamber 1001 also changes. When the object 1015 to be heated is placed in the divided chamber 1028A, the distributions of a radio wave amount and absorbed power that are absorbed by the object 1015 also vary depending on the phase difference. Therefore, it becomes possible to stir the electric field distribution in the divided chamber 1028A by changing the phase difference. By changing the phase difference and stirring the electric field distribution in the divided chamber 1028A, the object 1015 to be heated can be heated with a combination of different absorbed power distributions, and uniform heating of the object 1015 to be heated can be achieved.

The microwave radiator 1004A and the microwave radiator 1004B radiate microwaves to the heating chamber 1001 from positions facing each other. According to this configuration, by controlling the phase of the microwaves radiated from the position facing each other to the heating chamber 1001, the microwaves are reflected by an inner wall of the heating chamber 1001, and it becomes possible to control superposition of electric fields of direct waves before the radiation direction and the phase are disturbed. Due to this, when the phase difference is pi, for example, it becomes possible to strongly heat the center of the heating chamber 1001, and it becomes possible to heat the periphery of the center with the phase difference being zero. When the phase difference is pi/2, a biased microwave distribution is obtained. Due to this, by controlling the phases of the microwaves radiated by the microwave radiators 1004A and 1004B and controlling the microwave distribution in the heating chamber 1001, uniform heating and selective heating of the object 1015 to be heated become possible. The radiation positions of the microwaves whose phases are controlled may be designed to have a distance of one wavelength or more at the frequency to be radiated.

### 1.10.3 Example of Tenth Embodiment

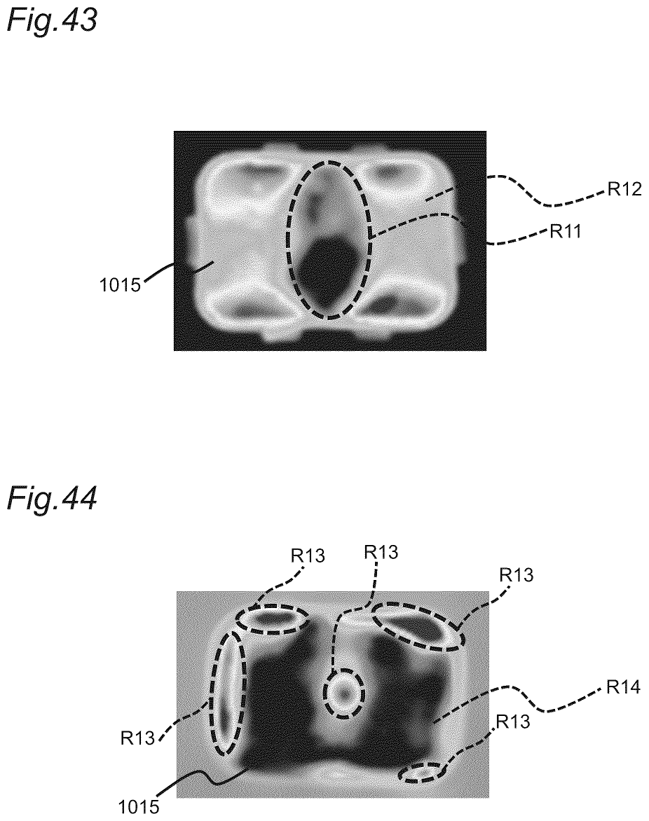

That use of a plurality of combinations of frequency and phase difference can uniformly heat the object 1015 to be heated will be further described with reference to FIGS. 43 to 47. In FIGS. 43 to 47, the object 1015 to be heated is, for example, frozen lasagna, and has a rectangular shape in plan view. That is, FIGS. 43 to 47 show the temperature distribution during thawing of the frozen lasagna. Hereinafter, an example of a case of performing microwave heating of the object 1015 to be heated placed in the heating chamber 1001 in a state where the divider 1005 is removed from the heating chamber 1001 will be described. Also a case of performing microwave heating on the object 1015 to be heated disposed in the divided chamber 1028A in a state where the divider 1015 is installed in the heating chamber 1001 as shown in FIG. 42 is deemed to have a similar tendency.

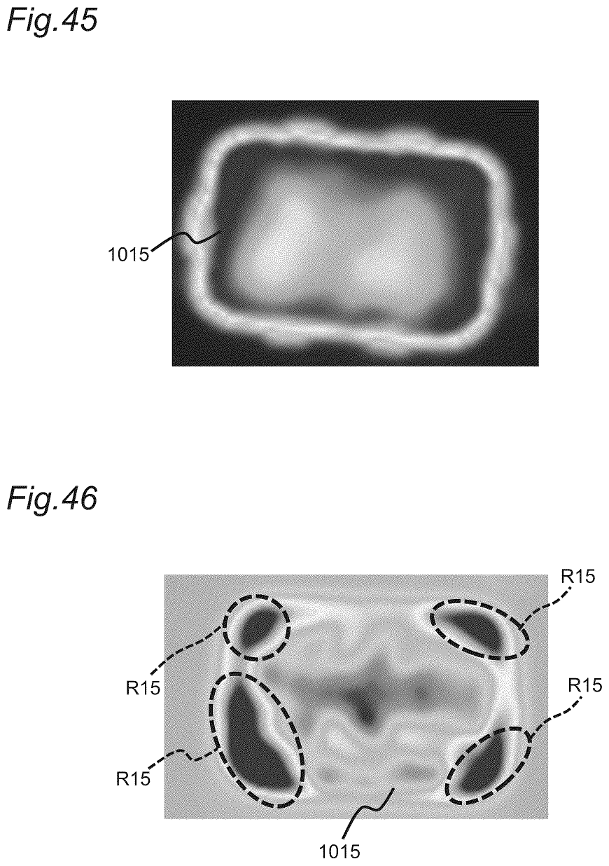

FIG. 43 is a view for explaining the heating distribution of the object 1015 to be heated in a case of the phase difference of 0°. As shown in FIG. 43, when the phase difference between the microwaves radiated from the two microwave radiators 1004A and 1004B is 0°, a region R12 around a center region R11 of the object 1015 to be heated is higher in temperature than the center region R11. FIG. 44 is a view for explaining the heating distribution of the object 1015 to be heated in a case of the phase difference of 180°. As shown in FIG. 44, when the phase difference between the microwaves radiated from the two microwave radiators 1004A and 1004B is 180°, the center region of the object 1015 to be heated and a region R13 on a front surface side of the object 1015 to be heated are higher in temperature than a region R14 around the center. Therefore, it is considered that the object 1015 to be heated can be uniformly heated by combining heating in which the phase difference between the microwaves emitted from the two microwave radiators 1004A and 1004B is 0° and heating in which the phase difference between the microwaves emitted from the two microwave radiators 1004A and 1004B is 180°. FIG. 45 is a view for explaining the heating distribution of the object 1015 to be heated in a case of combining the phase difference 0° and the phase difference 180°. As is apparent from FIG. 45, it has been confirmed that the object 1015 to be heated can be uniformly heated by combining heating in which the phase difference between the microwaves emitted from the two microwave radiators 1004A and 1004B is 0° and heating in which the phase difference between the microwaves emitted from the two microwave radiators 1004A and 1004B is 180°.

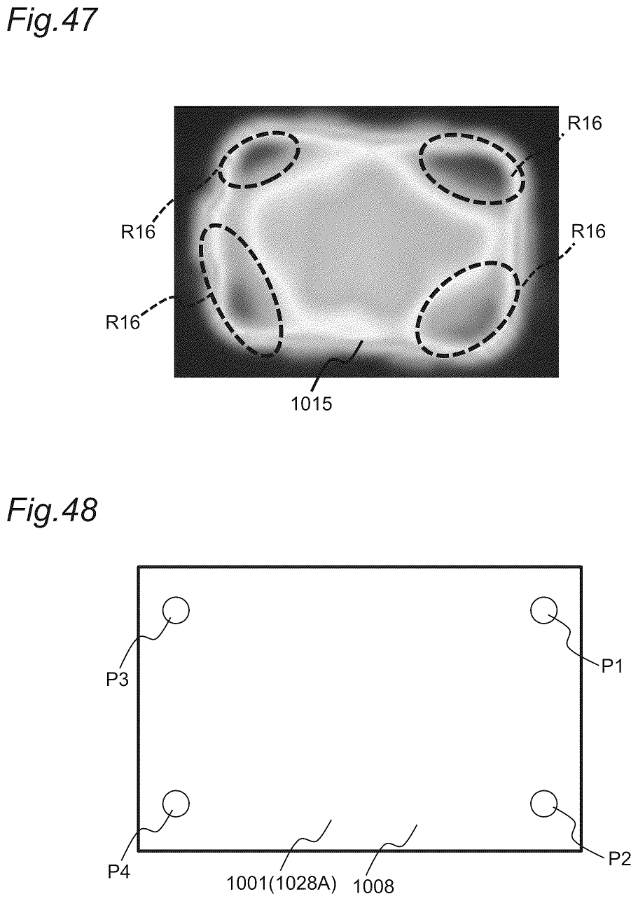

FIG. 46 is a view for explaining the heating distribution of the object 1015 to be heated of the comparative example. The comparative example is a conventional microwave oven that rotates, by a turntable, and heats the object 1015 to be heated. In this case, as is apparent from FIG. 46, it is seen that the temperature in regions R15 at the four corners of the object 1015 to be heated is higher than that in the center part, and the object 1015 to be heated is heated from the four corners. FIG. 47 is a view for explaining the heating distribution of the object 1015 to be heated after the heating processing is performed in the comparative example. As is apparent from FIG. 47, regions R16 at the four corner of the object 1015 to be heated are apparently higher in temperature than the center part. Therefore, the four corners of the object 1015 to be heated are excessively heated before the center part thereof is sufficiently heated. If the object 1015 to be heated is the frozen lasagna, the dough at the four corners of the frozen lasagna is dehydrated or burnt before the center part of the frozen lasagna is sufficiently thawed.

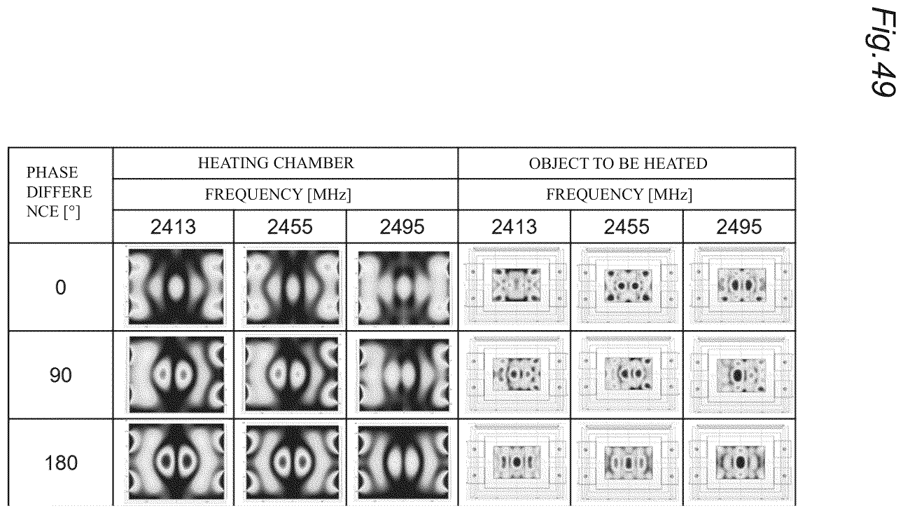

Next, simulation of the radio wave distribution of the heating chamber and the heating distribution of the object to be heated by the frequency and the phase difference will be described with reference to FIGS. 48 and 49. FIG. 48 is a view for explaining the model used for the simulation of the radio wave distribution of the heating chamber and the heating distribution of the object to be heated by the frequency and the phase difference. The model shown in FIG. 48 includes four power feed points P1 to P4. For example, the power feed points P1 and P2 correspond to the microwave radiator 1004A, and the power feed points P3 and P4 correspond to the microwave radiator 1004B. In the model shown in FIG. 48, the four power feed points P1 to P4 are present at the four corners of a bottom wall surface 1008 of the heating chamber 1001. More specifically, the power feed points P1 and P2 are on a first end side (right side in FIG. 48) in a length direction of the bottom wall surface 1008, and the power feed points P3 and P4 are on a second end side (left side in FIG. 48) in the length direction of the bottom wall surface 1008.

FIG. 49 is a view for explaining the difference between the radio wave distribution in the heating chamber and the heating distribution of the object to be heated by the frequency and the phase difference in the model shown in FIG. 48. The frequencies of the radio waves radiated from the four power feed points P1 to P4 are equal, and are any of 2413 MHz, 2455 MHz, and 2495 MHz. The phase difference is a phase difference between the radio waves radiated from the power feed points P1 and P2 and the radio waves radiated from the power feed points P3 and P4, and changes the phases of the radio waves radiated from the power feed points P3 and P4.

As is apparent from FIG. 49, the radio wave distribution in the heating chamber 1001 greatly changes depending on the combination of the frequency and the phase difference. The heating distribution of the object 1015 to be heated greatly changes depending on the combination of the frequency and the phase difference. Thus, the radio wave distribution in the heating chamber 1001 and the heating distribution of the object 1015 to be heated are uniquely determined by the combination of the frequency and the phase difference of the plurality of radio waves. Accordingly, the radio wave distribution in the heating chamber 1001 and the heating distribution of the object 1015 to be heated can be controlled by the combination of the frequency and the phase difference.

At least one of the dimensions of a height, a width, and a depth of the heating chamber 1001 may be a half wavelength or less of radio waves emitted from the microwave radiators 1004A and 1004B. The radio wave distribution (electric field distribution) is less likely to occur in a direction having a dimension a half wavelength or less of radio waves emitted from the microwave radiators 1004A and 1004B in the heating chamber 1001, and therefore the radio wave distribution in the heating chamber 1001 can be easily controlled by the frequency and the phase difference. In particular, at least one of the dimensions of the height, the width, and the depth of the heating chamber 1001 may be ¼ or less of the wavelength of the radio waves emitted from the microwave radiators 1004A and 1004B. The radio wave distribution (electric field distribution) does not occur in a direction having a dimension of ¼ or less of the wavelength of radio waves emitted from the microwave radiators 1004A and 1004B in the heating chamber 1001, and therefore the radio wave distribution in the heating chamber 1001 can be more easily controlled by the frequency and the phase difference. Thus, whether or not to generate the radio wave distribution can be determined by the shape of the heating chamber 1001. Therefore, it is possible to improve controllability of the radio wave distribution in the heating chamber 1001. This makes it easy to selectively execute uniform heating and selective heating of the object 1015 to be heated. When the object 1015 to be heated is present in the heating chamber 1001, the presence of the object 1015 to be heated affects the radio wave distribution in the heating chamber 1001, but if the object 1015 to be heated has a size that is practical enough to be assumed to be accommodated in the heating chamber 1001, the radio wave distribution in the heating chamber 1001 can be controlled by the frequency and the phase difference.

When the divider 1005 is installed in the heating chamber 1001, the dimension of the divided chamber 1028A in which the object 1015 to be heated is disposed may be designed as described above.

### 1.11 Eleventh Embodiment

### 1.11.1 Configuration

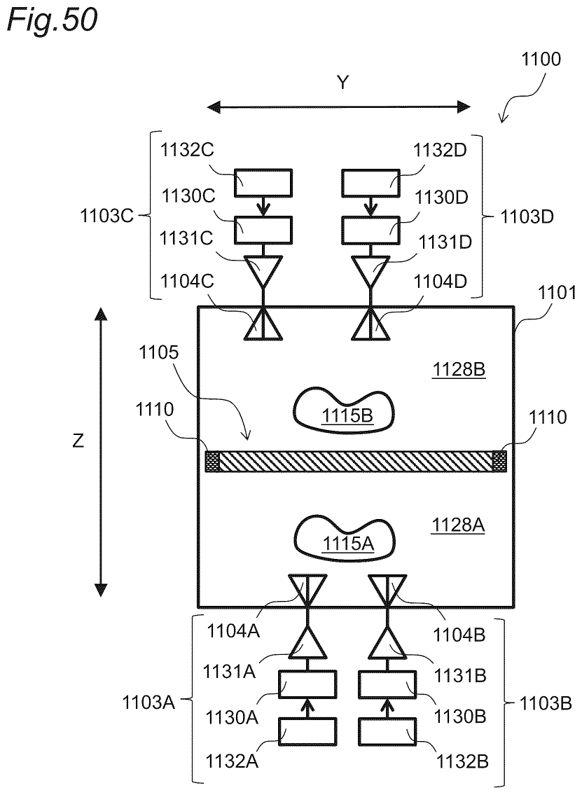

FIG. 50 is a schematic front view of a configuration example of a microwave heating device 1100 according to the eleventh embodiment. As shown in FIG. 50, the heating device 1100 includes a divider 1105 that divides a heating chamber 1101. The heating chamber 1101 is divided in the height direction Z by the divider 1105 to form two divided chambers 1128A and 1128B. An object 1115A to be heated is disposed in the lower divided chamber 1128A, and an object 111BA to be heated is disposed in the upper divided chamber 1128B.

The microwave heating device 1100 includes four microwave supply units 1103A to 1103D. The microwave supply units 1103A and 1103B are provided on a bottom surface side of the heating chamber 1101 so as to supply microwaves toward the lower divided chamber 1128A, and microwave supply units 1103C and 1103D are provided on a top surface side of the heating chamber 1101 so as to supply microwaves toward the upper divided chamber 1128B.

The microwave supply units 1103A to 1103D respectively include a plurality of microwave radiators 1104A to 1104D, a plurality of microwave signal generators 1130A to 1130D, a plurality of signal amplification units 1131A to 1131D, and a plurality of microwave control units 1132A to 1132D.

Each of the microwave control units 1132A to 1132D also serves as a “frequency control unit” and a “power control unit”. Each of the microwave control units 1132 to 1132D has both a function of controlling the frequency of microwaves and a function of controlling the power of microwaves.

The microwave control units 1132A to 1132D as the frequency control units control the frequencies of the radio waves emitted by the microwave radiators 1104A to 1104D, respectively. For example, the microwave control units 1132A to 1132D control the frequencies of the radio waves emitted by the microwave radiators 1104A to 1104D, respectively, within a predetermined frequency range. The predetermined frequency range may be appropriately selected from frequency ranges available for dielectric heating of the objects 1115A and 1115B to be heated. By controlling the frequencies of the radio wave signals generated by the radio wave signal generators 11320 to 1130D, the microwave control units 1132A to 1132D respectively control the frequencies of the radio waves emitted by the microwave radiators 1104A to 1104D. The microwave control units 1132A to 1132D can be used for changing the frequencies of the microwaves emitted by the microwave radiators 1104A to 1104D in accordance with the objects 1115A and 1115B to be heated. Each of the microwave control units 1132A to 1132D as frequency control units can be deemed to be a frequency variable unit.

The microwave control units 1132A to 1132D as power control units respectively control output of radio waves emitted by the microwave radiators 1104A to 1104D. By controlling the magnitude of the microwave signals generated by the microwave signal generators 1130A to 1130D, the microwave control units 1132A to 1132D respectively control the output of the radio waves emitted by the microwave radiators 1104A to 1104D. The microwave control units 1132A to 1132D can be respectively used for changing the output of the microwaves emitted by the microwave radiators 1104A to 1104D in accordance with the objects 1115A and 1115B to be heated. Each of the microwave control units 1132A to 1132D as power control units can be deemed to be an output variable unit. The microwave control units 1132A to 1132D may respectively control the output of the radio waves emitted by the microwave radiators 1104A to 1104D by other means such as change of the amplification factors of the signal amplification units 1131A to 1131D and change of the voltage of an internal power source connected to the signal amplification units 1131A to 1131D.

The microwave control units 1132A to 1132D as frequency control units and power control units may be configured by, for example, one or more microcontrollers having processors and memories. The microwave control units 1132A to 1132D may be configured by, for example, a field-programmable gate array (FPGA), an application specific integrated circuit (ASIC), or the like.

### 1.11.2 Actions and Effects

The microwave heating device 1100 of the eleventh embodiment described above further includes microwave control units 1132A to 1132D as frequency control means that can vary the frequency of the microwave generated by the microwave signal generators 1130A to 1130D (microwave generators). According to this configuration, radio waves having an optimum frequency is emitted in accordance with the objects 1115A and 1115B to be heated having different permittivities. It becomes possible to change the microwave distribution in the heating chamber 1101. Due to this, the dielectric can be efficiently heated, and uniform heating becomes possible. The frequency optimum for heating varies depending on not only the permittivity of the dielectric but also the size, the weight, the container, and the placement position. Even when there is a difference described above in the dielectric, the present invention enables more efficient heating. Since a half depth varies depending on the difference in frequency even for an identical dielectric, it is effective to perform heating at an optimum frequency depending on whether the purpose is to heat mainly the vicinity of the surface or whether the purpose is to also heat the inside.

The microwave control units 1132A to 1132D as power variable means that can vary the power of the microwaves generated by the microwave signal generators 1130A to 1130D (microwave generators) are included. This configuration enables microwave heating at an output suitable for the objects 1115A and 1115B to be heated by precise output control in increments of several W. The objects 1115A and 1115B to be heated such as frozen items requiring heating by precise control of microwave output can be heated at an optimum microwave output, and can be heated at an appropriate temperature, which cannot be achieved by conventional output control in increments of several hundred W. It becomes possible to continue heating of the objects 1115A and 1115B to be heated by stably continuously oscillating low microwaves of several W. For the objects 1115A and 1115B to be heated that cannot be heated by high-output microwaves such as eggs, low-output microwave heating enables heating that prevents overheating while heat conducting in the objects 1115A and 1115B to be heated, and enables low-temperature heating that cannot be achieved by conventional high-power heating. This enables heating at an appropriate temperature (improvement in heating performance) and heating of the objects 1115A and 1115B to be heated (such as eggs) that have not been conventionally possible.

### 1.11.3 Example of Eleventh Embodiment

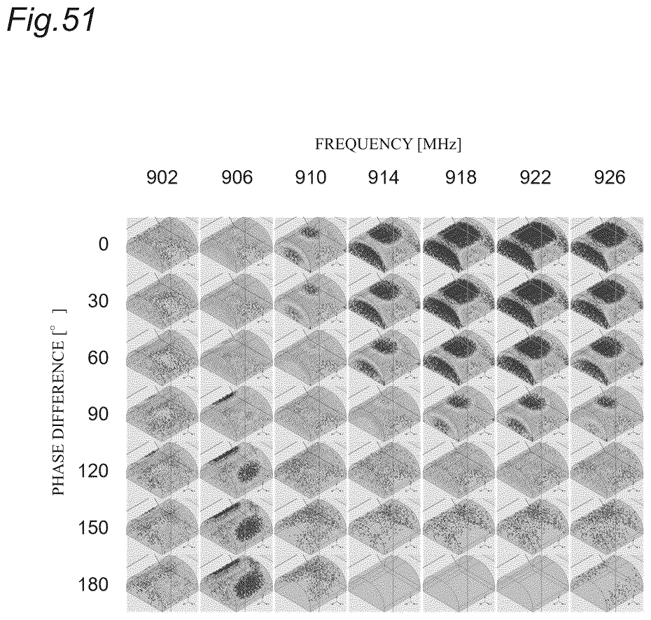

FIG. 51 is a view for explaining the difference in heating distribution of the object 1115A to be heated due to the frequency of radio waves emitted from the two microwave radiators 1104A and 1104B and the phase difference of radio waves emitted from the two microwave radiators 1104A and 1104B. Hereinafter, an example in a case of performing microwave heating on the object 1115A to be heated placed in the heating chamber 1101 in a state where the divider 1105 is removed from the heating chamber 1101 will be described. Also a case of performing microwave heating on the object 1115A to be heated disposed in the divided chamber 1128A in a state where the divider 1105 is installed in the heating chamber 1101 as shown in FIG. 50, and a case of performing microwave heating on the object 1115B to be heated disposed in the divided chamber 1128B are deemed to have a similar tendency.

FIG. 51 shows the heating distribution of the object 1115A to be heated with respect to a combination of the frequency of the radio waves emitted from the two microwave radiators 1104A and 1104B and the phase difference of the radio waves emitted from the two microwave radiators 1104A and 1104B. In FIG. 51, the frequencies are 902 MHZ, 906 MHz, 910 MHz, 914 MHz, 918 MHz, 922 MHz, and 926 MHz, and the phase differences are 0°, 30°, 60°, 90°, 120°, 150°, and 180°. The object 1115A to be heated is, for example, roasted beef.

As is apparent from FIG. 51, the heating distribution of the object 1115A to be heated greatly changes depending on the combination of the frequency and the phase difference. When the frequencies are 914 MHZ, 918 MHZ, 922 MHz, and 926 MHz, and the phase differences are 0°, 30°, and 60°, the temperature is high in the center part of the object 1115A to be heated and on both sides in the length direction. On the other hand, when the frequency is 906 MHz and the phase differences are 120°, 150°, and 180°, the temperature is high on both sides in the width direction of the object 1115A to be heated. Therefore, even in the identical object 1115A to be heated, a part to be heated can be selected by a combination of the frequency and the phase difference, and uniform heating becomes possible by using a plurality of combinations of the frequency and the phase difference.

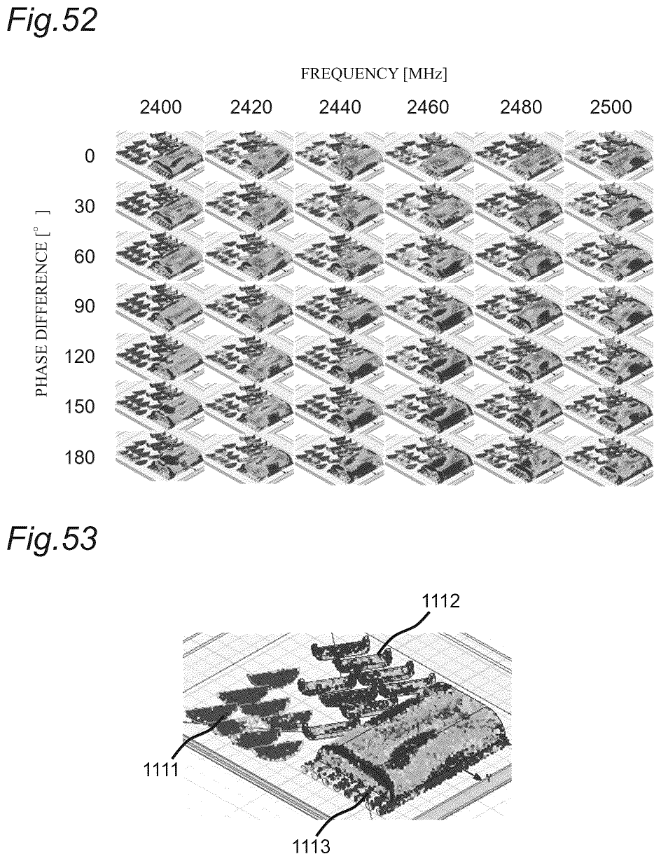

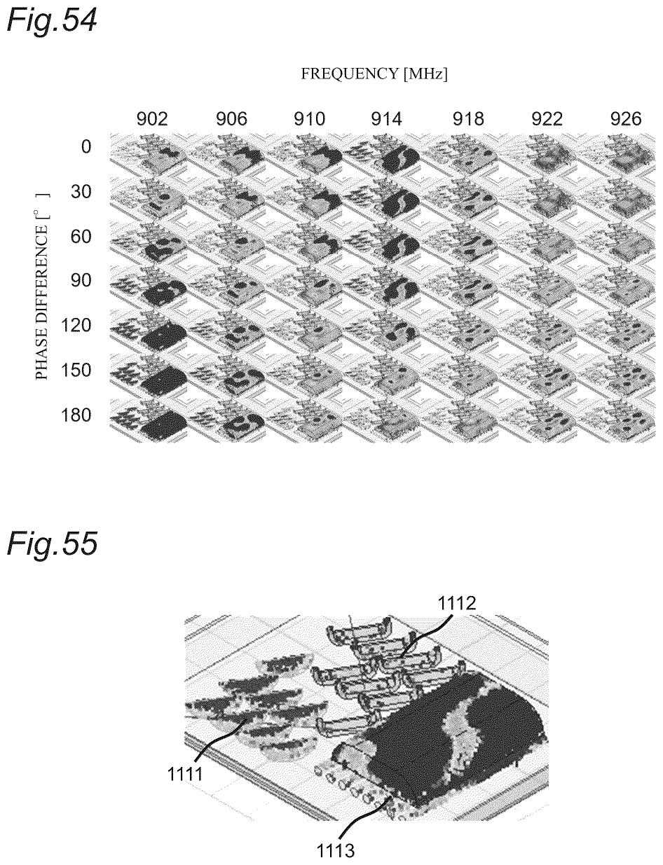

FIGS. 52 to 55 are views for explaining the difference in the heating distribution due to the frequency and the phase difference regarding of different types of the objects 1115A to be heated. FIGS. 52 and 54 show the heating distributions of objects 1111, 1112, and 1113 to be heated (see FIGS. 53 and 55) with respect to combinations of the frequency of the radio waves emitted from the two microwave radiators 1104A and 1104B and the phase differences of the radio waves emitted from the two microwave radiators 1104A and 1104B. The objects 1111 and 1112 to be heated are vegetables, for example. The object 1111 to be heated is potatoes, for example. The object 1112 to be heated is paprika, for example. The object 1113 to be heated is meat, for example. The object 1113 to be heated is beef, for example.

In FIG. 52, the frequencies are 2400 MHZ, 2420 MHz, 2440 MHZ, 2460 MHZ, 2480 MHz, and 2500 MHZ, and the phase differences are 0°, 30°, 60°, 90°, 120°, 150°, and 180°. FIG. 53 is a view showing the heating distribution of the objects 1111, 1112, and 1113 to be heated in the case of the phase difference of 0° and the frequency of 2400 MHz shown in FIG. 52. In FIG. 54, the frequencies are 902 MHZ, 906 MHz, 910 MHZ, 914 MHz, 918 MHz, 922 MHz, and 926 MHz, and the phase differences are 0°, 30°, 60°, 90°, 120°, 150°, and 180°. FIG. 55 is a view showing the heating distribution of the objects 1111, 1112, and 1113 to be heated in the case of the phase difference of 0° and the frequency of 914 MHz shown in FIG. 54.

As is apparent from FIGS. 52 to 55, the heating distribution greatly changes by the type of the objects 1111 to 1113 to be heated depending on the combination of the frequency and the phase difference. As shown in FIG. 52, when the frequency ranges from 2400 MHz to 2500 MHZ (2450±50 MHz), the objects 1111 and 1112 to be heated can be heated more than the object 1113 to be heated. Since the objects 1111 and 1112 to be heated are vegetables and the object 1113 to be heated is meat, the frequency from 2400 MHz to 2500 MHz is effective for selectively heating the vegetables (objects 1111 and 1112 to be heated) as shown in FIG. 53. As shown in FIG. 54, when the frequency ranges from 902 MHz to 928 MHz (915±13 MHZ), the object 1113 to be heated can be heated more than the objects 1111 and 1112 to be heated. Since the objects 1111 and 1112 to be heated are vegetables and the object 1113 to be heated is meat, the frequency from 902 MHz to 928 MHz is effective for selectively heating the meat (object 1113 to be heated) as shown in FIG. 55. Therefore, the objects 1111, 1112, and 1113 to be heated of different types can be selectively heated by a combination of the frequency and the phase difference, and the objects 1111, 1112, and 1113 to be heated of different types can be uniformly heated by using a plurality of combinations of the frequency and the phase difference.

### 1.12 Twelfth Embodiment

### 1.12.1 Configuration

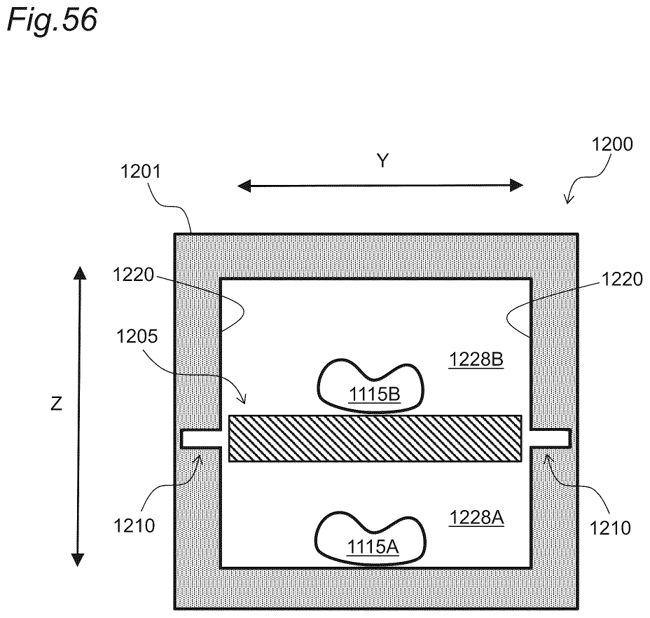

FIG. 56 is a schematic front view of a configuration example of a microwave heating device 1200 according to the twelfth embodiment. As shown in FIG. 56, the microwave heating device 1200 includes a heating chamber 1201 and a divider 1205 that divides the heating chamber 1201 in the height direction Z. The object 1115A to be heated is disposed in a lower divided chamber 1228A, and the object 1115B to be heated is disposed in an upper divided chamber 1228B.

In the present embodiment, the divider 1205 is not provided with a radio wave shielding structure such as a choke structure, and an inner wall 1220 of the heating chamber 1201 is provided with a non-contact radio wave shielding structure 1210. The divider 1205 is supported in contact with the inner wall 1220 of the heating chamber 1201 at a location other than a location facing the radio wave shielding structure 1210.

### 1.12.2 Actions and Effects

According to the microwave heating device 1200 of the twelfth embodiment described above, the inner wall 1220 of the heating chamber 1201 is provided with a radio wave shielding structure 1210. According to this configuration, the non-contact radio wave shielding structure 1210 can also be provided on the inner wall 1220 of the heating chamber 1201. A part of the radio wave shielding structure can be provided on the inner wall 1220 of the heating chamber 1201, and the remaining radio wave shielding structure can be provided in the divider 1205. Eliminating or simplifying the radio wave shielding structure of the divider 1205 has an effect of preventing deformation of the radio wave shielding structure due to contact of the objects 1115A and 1115B to be heated with the divider 1205 at the time of taking out the objects 1115A and 1115B to be heated, and deterioration of radio wave shielding performance associated with the deformation. It can be expected to also prevent deformation of the radio wave shielding structure when the divider 1205 is removed. This can achieve simplification of the structure of the divider 1205 and stabilization of the shielding performance.

### 1.13 Thirteenth Embodiment

### 1.13.1 Configuration

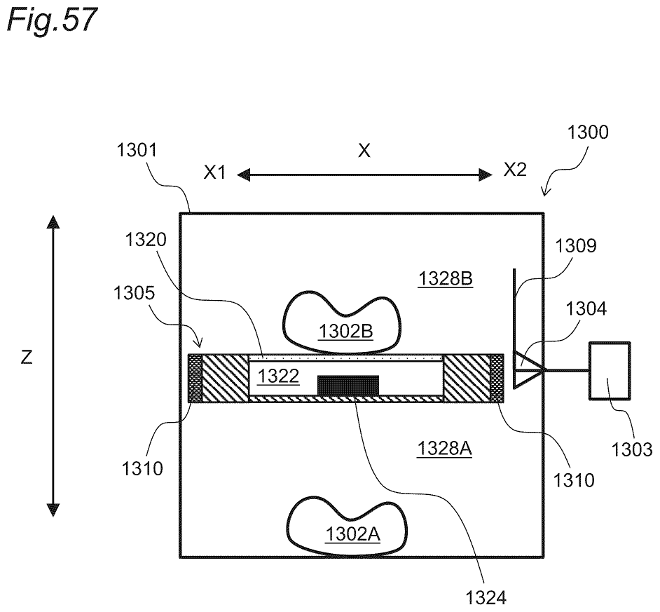

FIG. 57 is a schematic side view of a configuration example of a microwave heating device 1300 according to the thirteenth embodiment. As shown in FIG. 57, the microwave heating device 1300 includes a heating chamber 1301, a microwave generator 1303, a microwave radiator 1304, and a divider 1305.

The heating chamber 1301 shown in FIG. 57 is divided in the height direction Z by the divider 1305 to form two divided chambers 1328A and 1328B. The divider 1305 is made of a material such as metal that shields microwaves, for example, and includes a non-contact or contact radio wave shielding structure 1310. In FIG. 57, an object 1302A to be heated is disposed in the lower divided chamber 1328A, and an object 1302B to be heated is disposed in the upper divider 1328B.

The microwave generator 1303 and the microwave radiator 1304 are provided on a back surface side X2 of the heating chamber 1301. The microwave radiator 1304 radiates microwaves from the back surface of the heating chamber 1301 toward the heating chamber 1301. The microwave radiator 1304 further includes a rotation antenna 1309. The rotation antenna 1309 radiates microwaves to each of the divided chamber 1328A and the divided chamber 1328B in accordance with a rotational position, for example.

As shown in FIG. 57, the divider 1305 includes a placement surface 1320 for placing the object 1302B to be heated. The placement surface 1320 is made of a dielectric, for example. The divider 1305 forms a recess 1322 below the placement surface 1320, and a dielectric 1324 is disposed in the recess 1322.

### 1.13.2 Actions and Effects

According to the microwave heating device 1300 of the thirteenth embodiment described above, the placement surface 1320 is made of a dielectric, and the divider 1305 forms the recess 1322 below the placement surface 1320, and the recess 1322 is provided with dielectric 1324. According to this configuration, wavelength compression of microwaves occurs in the dielectric 1324 in accordance with the permittivity of the dielectric 1324. By installing the dielectric 1324 in the recess 1322, by the wavelength compression in the dielectric 1324, the microwave distribution around the dielectric 1324 becomes a microwave distribution different from that in a case without the dielectric 1324. Therefore, it becomes possible to uniform the heating distribution of the object 1302B to be heated in accordance with the permittivity, the shape, and the placement position of the dielectric 1324. This can achieve uniform heating.

Although the invention of the present disclosure has been described above with the above-described embodiments, the invention of the present disclosure is not limited to the above-described embodiments. Although the present disclosure has been fully described in connection with preferred embodiments with reference to the accompanying drawings, various modifications and alterations are apparent to those skilled in the art. Such modifications and alterations should be understood to be included in the scope of the invention according to the appended claims as long as they do not depart therefrom. Combinations of elements and changes in order in each embodiment can be achieved without departing from the scope and idea of the present disclosure.

By appropriately combining arbitrary embodiments among the above-described embodiments, the effects of the respective embodiments can be achieved.

### INDUSTRIAL APPLICABILITY

The present disclosure is applicable to any microwave heating device that heats and cooks an object to be heated such as food with microwaves.

### EXPLANATION OF REFERENCES

1 heating chamber
2A, 2B object to be heated
3 microwave generator
4 microwave radiator
5 divider
6A, 6B sensor
100 microwave heating device
101 control unit
102 bottom surface
104 top surface
X depth direction
Y width direction
Z height direction

1. A microwave heating device comprising:
a heating chamber in which an object to be heated is disposed;
a microwave generator that generates microwaves;
a microwave radiator that radiates microwaves generated by the microwave generator into the heating chamber; and
a divider that divides a space of the heating chamber into at least two divided chambers.

2. (canceled)

3. The microwave heating device according to claim 1, wherein two of the divided chambers are provided.

4-5. (canceled)

6. The microwave heating device according to claim 1, wherein two divided chambers of the divided chambers have a function of heating an object to be heated.

7. The microwave heating device according to claim 1, wherein the divider is detachable from an inner wall of the heating chamber.

8. The microwave heating device according to claim 7, wherein microwaves are radiated from the microwave radiator into the heating chamber in a state where the divider is removed from the heating chamber.

9. The microwave heating device according to claim 1, wherein the divider is made of a dielectric.

10. The microwave heating device according to claim 1, wherein the divider is made of metal.

11. The microwave heating device according to claim 1, wherein an insulator is provided between the divider and an inner wall of the heating chamber.

12. The microwave heating device according to claim 1, wherein the divider divides the heating chamber in a height direction.

13. The microwave heating device according to claim 1, wherein the divider divides the heating chamber in a width direction.

14-15. (canceled)

16. The microwave heating device according to claim 1, wherein the divider includes a placement surface on which an object to be heated is placed.

17. The microwave heating device according to claim 16, wherein the placement surface is made of a dielectric, and the divider defines a recess below the placement surface.

18. The microwave heating device according to claim 17, wherein the recess is provided with a dielectric.

19. The microwave heating device according to claim 17, wherein the recess is provided with metal.

20. (canceled)

21. The microwave heating device according to claim 1, wherein at least one of the divided chambers is provided with an infrared sensor.

22-24. (canceled)

25. The microwave heating device according to claim 1, wherein
the divided chamber includes a first divided chamber and a second divided chamber, and
the first divided chamber is provided with a first sensor, and the second divided chamber is provided with a second sensor that is a different type of the first sensor.

26-28. (canceled)

29. The microwave heating device according to claim 1, wherein the microwave radiator radiates microwaves to the heating chamber from a back surface of the heating chamber.

30. The microwave heating device according to claim 1, wherein the microwave radiator includes a rotation antenna.

31-33. (canceled)

34. The microwave heating device according to claim 1, wherein the microwave radiator has a function of simultaneously radiating microwaves in a first direction and a second direction.

35. The microwave heating device according to claim 34, wherein the microwave radiator has a function of simultaneously radiating microwaves to a plurality of the divided chambers using microwaves radiated in the first direction and the second direction.

36. (canceled)

37. The microwave heating device according to claim 1, wherein the divider is provided with a radio wave shielding structure of at least one direction.

38. (canceled)

39. The microwave heating device according to claim 1, wherein at least one side of the divider is provided with a radio wave shielding structure.

40-43. (canceled)

44. The microwave heating device according to claim 1, wherein a first side of the divider is provided with a first radio wave shielding structure, and a second side of the divider is provided with a second radio wave shielding structure different from the first radio wave shielding structure.

45-46. (canceled)

47. The microwave heating device according to claim 37, wherein the radio wave shielding structure is non-contact and is provided on a side other than a door side in the divider.

48-49. (canceled)

50. The microwave heating device according to claim 1, wherein the radio wave shielding structure includes a contact-type of first radio wave shielding structure and a non-contact-type of second radio wave shielding structure.

51. The microwave heating device according to claim 37, wherein the radio wave shielding structure includes a dielectric cover.

52-59. (canceled)
